(19) United States
(12) Patent Application Publication
(10) Pub. No.: US 2022/0261834 A1
(43) Pub. Date: Aug. 18, 2022

(54) INFORMATION PROCESSING APPARATUS, TERMINAL APPARATUS, AND SECOND TERMINAL APPARATUS

(71) Applicant: Kura Sushi, Inc., Osaka (JP)

(72) Inventors: Kunihiko TANAKA, Osaka (JP); Daisuke HASHIMOTO, Osaka (JP)

(21) Appl. No.: 17/627,463

(22) PCT Filed: Mar. 30, 2020
(86) PCT No.: PCT/JP2020/014450

§ 371 Date: Jan. 14, 2022

(30) Foreign Application Priority Data
Jul. 16, 2019 (JP) 2019-130814

(51) Int. Cl. G06Q 30/02; G06Q 50/12

(52) U.S. Cl. CPC G06Q 30/0212; G06Q 50/12

(57) ABSTRACT

An the information processing apparatus includes: a reward condition storage unit in which a reward condition for performing reward processing, which is processing that provides a reward, is stored; an order information receiving unit that receives one or more pieces of order information, each of which is information regarding an order for an item, is information having seat specifying information for specifying a seat, and is information transmitted from a terminal apparatus; a determining unit that determines whether or not one or more pieces of order information received by the order information receiving unit and corresponding to one seat identifier for identifying a seat match the reward condition; and a reward processing unit that performs the reward processing on the seat identified with the one seat identifier, in a case in which the determining unit determines that order information matches the reward condition.

### TECHNICAL FIELD

The present invention relates to an information processing apparatus for performing reward processing that receives one or more pieces of order information transmitted from a terminal apparatus and provides a reward in the case in which a predetermined reward condition is satisfied, a terminal apparatus, and a second terminal apparatus.

### BACKGROUND ART

Conventionally, there are plate collecting apparatuses for collecting plates after a meal from tables at restaurants, including: a plate collecting portion that collects plates at a predetermined position; a plate detecting part that detects that plates have been collected at the plate collecting portion; a control part that generates pseudo-random number information in the case in which the plate detecting part detects a predetermined number of plates, and selects and outputs a predetermined output pattern associated in advance with the pseudo-random number information based on the generated pseudo-random number information; and a prize providing part including an accommodating container in which multiple prizes are accommodated and a prize ejecting mechanism that ejects a prize in the accommodating container. In the plate collecting apparatus, the control part includes a winner determining part that compares wining information set in advance and the generated pseudo-random number information, and, if the pieces of information match each other, determines that a prize is won, wherein, in the case in which it is determined that a prize is won, the prize ejecting mechanism of the prize providing part is operated to eject a prize in the accommodating container (see Patent Document 1, for example).

### CITATION LIST

### Patent Document

Patent Document 1: Japanese Patent No. 3859962

### SUMMARY OF INVENTION

### Technical Problem

Incidentally, in recent years, terminal apparatuses such as so-called smart phones have been widely used. It is expected to be able to provide users, such as customers of restaurants, with a high value-added experience of purchasing items and using services by using such terminal apparatuses.

### Solution to Problem

A first aspect of the present invention is directed to an information processing apparatus including: a reward condition storage unit in which a reward condition for performing reward processing, which is processing that provides a reward, is stored; an order information receiving unit that receives one or more pieces of order information, each of which is information regarding an order for an item, is information having seat specifying information for specifying a seat, and is information transmitted from a terminal apparatus; a determining unit that determines whether or not one or more pieces of order information received by the order information receiving unit and corresponding to one seat identifier for identifying a seat match the reward condition; and a reward processing unit that performs reward processing on the seat identified with the one seat identifier, in a case in which the determining unit determines that order information matches the reward condition.

With this configuration, it is possible to provide a reward to a seat, using order information regarding an order at a terminal apparatus.

Furthermore, a second aspect of the present invention is directed to the information processing apparatus according to the first aspect, wherein the reward condition is a condition only regarding order information for predetermined one or more items out of two or more items.

With this configuration, it is possible to set only a specific item (e.g., udon) as an item that is subject to a reward to a seat.

Furthermore, a third aspect of the present invention is directed to the information processing apparatus according to the first aspect, wherein the reward processing unit includes: a drawing processing part that performs drawing processing that determines a drawing result; and a reward providing part that performs reward providing processing that provides a reward to the seat identified with the one seat identifier.

With this configuration, it is possible to provide a reward to a seat, if drawing processing is performed and a customer group is selected as a winner.

Furthermore, a fourth aspect of the present invention is directed to the information processing apparatus according to the first aspect, wherein the reward processing includes transmission processing of a prize output instruction to a prize output apparatus for outputting a prize.

With this configuration, it is possible to provide a prize to a customer at a seat, by transmitting a prize output instruction to the prize output apparatus.

Furthermore, a fifth aspect of the present invention is directed to the information processing apparatus according to the first aspect, wherein the order information receiving unit receives order information having seat specifying information corresponding to a same seat, from two or more terminal apparatuses.

With this configuration, it is possible to provide a reward to a seat, using order information from two or more terminal apparatuses of two or more customers at the same seat.

Furthermore, a sixth aspect of the present invention is directed to the information processing apparatus according to the first aspect, further including: a status information acquiring unit that acquires status information, which is information related to one or more pieces of order information corresponding to the one seat identifier and a reward condition and is information regarding an ordering status, using a determination result of the determining unit; and a status information transmitting unit that transmits the status information to the terminal apparatus.

With this configuration, it is possible to transmit status information related to order information and a reward condition, to a terminal apparatus.

Furthermore, a seventh aspect of the present invention is directed to the information processing apparatus according to the sixth aspect, wherein the status information transmitting unit transmits different types of status information between cases in which the determining unit gives a determination result indicating that order information matches the reward condition and a determination result indicating that order information does not match the reward condition, or transmits status information only in a case in which the determining unit gives a determination result indicating that order information matches the reward condition.

With this configuration, it is possible to appropriately transmit status information related to order information and a reward condition, to a terminal apparatus.

Furthermore, an eighth aspect of the present invention is directed to the information processing apparatus according to the sixth aspect, further including a terminal management information storage unit in which one or more pieces of terminal management information having a seat identifier, one or at least two terminal identifiers, and parent-child distinguishing information for distinguishing one parent terminal apparatus from one or more child terminal apparatuses are stored, wherein the status information transmitting unit transmits status information only to the parent terminal apparatus specified with the parent-child distinguishing information.

With this configuration, it is possible to transmit status information related to order information and a reward condition, only to a parent terminal apparatus.

Furthermore, a ninth aspect of the present invention is directed to the information processing apparatus according to the eighth aspect, further including: a registration information receiving unit that receives registration information from one or at least two terminal apparatuses; and a registration information accumulating unit that accumulates a terminal identifier contained in the registration information received by the registration information receiving unit, in the terminal management information storage unit, in association with a seat identifier contained in the registration information received by the registration information receiving unit, wherein the determining unit determines whether or not two or more pieces of order information with a same seat identifier that is paired with a terminal identifier, which is seat specifying information contained in the order information received by the order information receiving unit, match the reward condition.

With this configuration, it is possible to provide a reward to a seat, using order information from two or more terminal apparatuses, using registration information of the two or more terminal apparatuses of customers at the same seat.

Furthermore, a tenth aspect of the present invention is directed to the information processing apparatus according to the first aspect, further including a seat delivery information receiving unit that receives seat delivery information, which is information having a seat identifier and an item identifier and is information indicating that an item identified with an item identifier contained in order information has been delivered to a seat, wherein the determining unit determines whether or not one or more pieces of order information corresponding to a seat identifier contained in the seat delivery information, the order information being one or more pieces of order information corresponding to an item identifier contained in the seat delivery information, match the reward condition.

With this configuration, it is possible to accept cancellation of an order for an item, if the order is confirmed at the actual arrival of the item at the seat.

Furthermore, an eleventh aspect of the present invention is directed to the information processing apparatus according to the first aspect, wherein the order information receiving unit also receives one or more pieces of second order information, each of which is information having a seat identifier and is order information from an apparatus different from the terminal apparatus, and the determining unit determines whether or not one or more pieces of order information transmitted from the terminal apparatus and one or more pieces of second order information corresponding to a same seat identifier as that of the one or more pieces of order information match the reward condition.

With this configuration, it is possible to provide a reward to a seat, also in consideration of order information via a route from an apparatus different from the terminal apparatus.

Furthermore, a twelfth aspect of the present invention is directed to a terminal apparatus including: a terminal storage unit in which seat specifying information is stored; a terminal accepting unit that accepts an ordering instruction having an item identifier; a terminal configuring unit that configures order information containing the item identifier contained in the ordering instruction and the seat specifying information; a terminal transmitting unit that transmits the order information configured by the terminal configuring unit; a terminal acquiring unit that acquires status information for reward processing; and a terminal output unit that outputs the status information.

With this configuration, it is possible to output status information for reward processing.

Furthermore, a thirteenth aspect of the present invention is directed to the terminal apparatus according to the twelfth aspect, wherein the status information is screen information indicating that the procedure is allowed to advance to the reward processing, the terminal accepting unit accepts a terminal reward instruction, which is an instruction to screen information output by the terminal output unit and is an instruction to advance the procedure to the reward processing, and the terminal apparatus further includes a terminal transmitting unit that transmits a reward instruction, which is an instruction to perform reward processing, in response to acceptance of the terminal reward instruction.

With this configuration, it is possible to determine whether or not to advance the procedure for a customer with a terminal apparatus to reward processing.

Furthermore, a fourteenth aspect of the present invention is directed to the terminal apparatus according to the twelfth aspect, wherein child apparatus authentication information for authenticating one or more child terminal apparatuses is stored in the terminal storage unit, and the terminal output unit outputs the child apparatus authentication information.

With this configuration, it is possible to perform processing for performing registration of a second terminal apparatus, which is a child terminal apparatus.

Furthermore, a fifteenth aspect of the present invention is directed to a second terminal apparatus including: a second terminal storage unit in which a second terminal identifier for identifying a child terminal apparatus is stored; a second terminal accepting unit that accepts child apparatus authentication information; and a second terminal transmitting unit that transmits registration information having the second terminal identifier and seat specifying information for specifying a seat, to an information processing apparatus, in response to acceptance of the child apparatus authentication information.

With this configuration, it is possible to perform processing for performing registration of a second terminal apparatus, which is a child terminal apparatus.

Furthermore, a sixteenth aspect of the present invention is directed to the second terminal apparatus according to the fifteenth aspect, further including: a second terminal receiving unit that receives order screen information of two or more items, in response to transmission of the registration information; and a second terminal output unit that outputs the order screen information.

With this configuration, it is possible to output an order screen in response to transmission of registration information.

### Advantageous Effects of Invention

With the information processing apparatus according to the present invention, it is possible to provide a reward to a seat, using order information regarding an order at a terminal apparatus.

### BRIEF DESCRIPTION OF DRAWINGS

FIG. 1 is a schematic diagram of an information system according to Embodiment 1 of the present invention.

FIG. 2 is a block diagram of the information system in this embodiment.

FIG. 3 is a block diagram of an information processing apparatus in this embodiment.

FIG. 4 is a flowchart showing an example of an operation of the information processing apparatus in this embodiment.

FIG. 5 is a flowchart showing an example of terminal registration processing in this embodiment.

FIG. 6 is a flowchart showing an example of reward processing in this embodiment.

FIG. 7 is a flowchart showing an example of an operation of a terminal apparatus in this embodiment.

FIG. 8 is a flowchart showing an example of an operation of a second terminal apparatus in this embodiment.

FIG. 9 is a first diagram showing a screen change example in terminal processing in this embodiment.

FIG. 10 is a second diagram showing a screen change example in terminal processing in this embodiment.

FIG. 11 is a third diagram showing a screen change example in terminal processing in this embodiment.

FIG. 12 is a fourth diagram showing a screen change example in terminal processing in this embodiment.

FIG. 13 is a schematic view of a computer system in the foregoing embodiment.

FIG. 14 is a block diagram of the computer system in this embodiment.

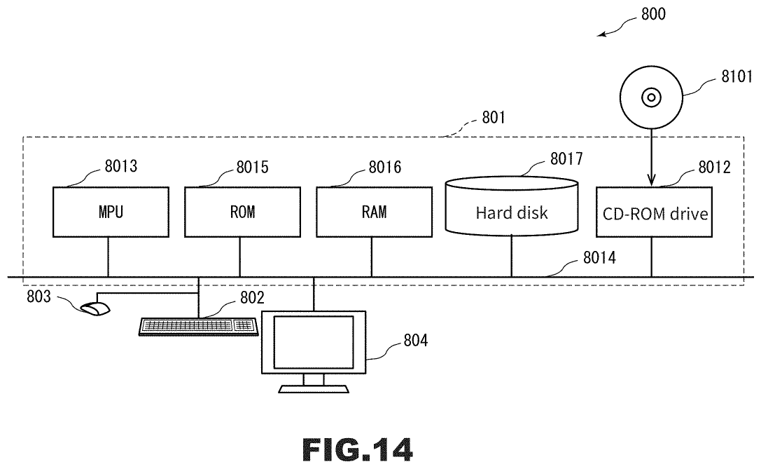

### DESCRIPTION OF EMBODIMENT

Hereinafter, an embodiment of an information processing apparatus and the like will be described with reference to the drawings. It should be noted that constituent elements denoted by the same reference numerals in the embodiments perform similar operations, and thus a description thereof may not be repeated.

The terms used hereinafter are generally defined as follows. The meanings of these terms should not always be interpreted as indicated herein, but should be interpreted in light of, for example, individual explanations, if any, given below.

An identifier for a certain matter is a text character, a sign, or the like for uniquely indicating the matter concerned. The identifier is, for example, an ID, but any type of information with which the corresponding matter can be identified. That is, the identifier may be a name of the matter itself that it indicates, or it may be a set of signs that are combined so as to uniquely correspond to the matter.

The acquiring may encompass acquiring matters input by a user or the like, or acquiring information stored in another apparatus. The acquiring information stored in another apparatus may encompass acquiring information stored in the other apparatus via an API or the like. The acquiring information stored in another apparatus may encompass acquiring the content of a document file (including the content of a web page) provided by the other apparatus by scraping or the like. It may also encompass acquiring information in a different format from that of the original information, such as acquiring information by performing optical character recognition on an image file.

The outputting information is a concept that encompasses display on a display screen, projection using a projector, printing by a printer, output of a sound, transmission to an external apparatus, delivery of a processing result to another processing apparatus or another program, and the like. Specifically, it encompasses, for example, enabling the display of information on a web page, transmitting the information as e-mail or the like, and outputting the information for printing.

The accepting information is a concept that encompasses accepting information input via an input device such as a keyboard, a mouse, or a touch panel, receiving information transmitted via a wired or wireless communication line from another apparatus or the like, and accepting information read from a storage medium such as an optical disk, a magnetic disk, or a semiconductor memory.

### Embodiment 1

In Embodiment 1, an information processing apparatus for performing reward processing that receives one or more pieces of order information transmitted from a terminal apparatus and provides a reward in the case in which a predetermined reward condition is satisfied will be described. In this example, the reward condition may be a condition only regarding order information for predetermined one or more items out of two or more items. The information processing apparatus may perform reward providing processing, if drawing processing is performed and a customer group is selected as a winner. The reward providing processing may be transmission of a prize output instruction to a prize output apparatus 4. The information processing apparatus may determine whether or not a condition is satisfied by order information from two or more terminal apparatuses corresponding to the same seat identifier. The information processing apparatus may transmit status information related to order information and a reward condition, to a terminal apparatus. The information processing apparatus may transmit status information indicating that a reward condition is satisfied, to a terminal apparatus, in the case in which the reward condition is satisfied. The information processing apparatus may transmit state information, only to a parent terminal apparatus out of two or more terminal apparatuses at the same seat. The information processing apparatus may receive registration information from a terminal apparatus. The information processing apparatus may detect that an ordered item has been delivered to a seat, and determine whether or not a reward condition is satisfied. The information processing apparatus may determine whether or not a reward condition is satisfied by order information from a terminal apparatus and other second order information corresponding to a seat.

Furthermore, in Embodiment 1, a terminal apparatus that accepts one or more pieces of order information, and outputs status information for reward processing will be described. In this example, the terminal apparatus may transmit a reward instruction, which is an instruction to perform reward processing, after a predetermined reward condition is satisfied and an instruction to advance the procedure to the reward processing is accepted. The terminal apparatus may output child apparatus authentication information for authenticating a second terminal apparatus serving as a child apparatus.

Furthermore, in Embodiment 1, a second terminal apparatus that accepts child apparatus authentication information, and transmits registration information having a seat identifier and a second terminal identifier to an information processing apparatus will be described. The second terminal apparatus may receive order screen information in response to transmission of registration information.

Hereinafter, an example of an information system A having the information processing apparatus, the terminal apparatus, and the second terminal apparatus as described above will be described.

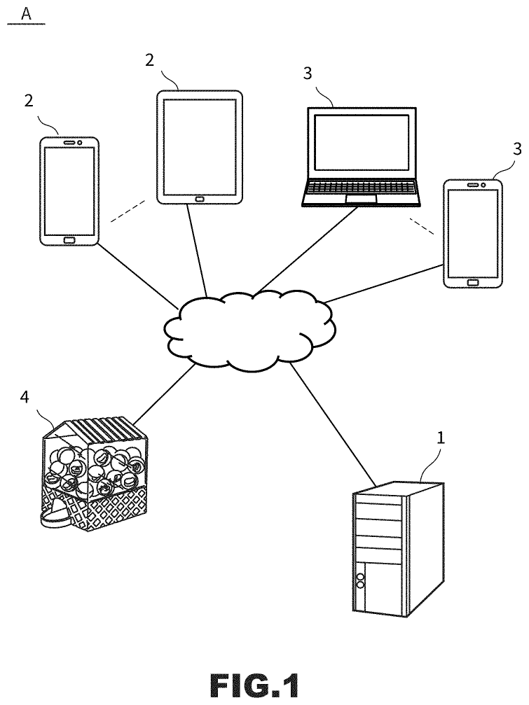

FIG. 1 is a schematic diagram of the information system A according to Embodiment 1 of the present invention.

As shown in FIG. 1, in this embodiment, the information system A includes an information processing apparatus 1, terminal apparatuses 2, second terminal apparatuses 3, and a prize output apparatus 4. The information processing apparatus 1, the terminal apparatuses 2, the second terminal apparatuses 3, and the prize output apparatus 4 can communicate with each other via a network, such as a local area network or the Internet, for example. The configuration of the information system A is not limited to this. There is no limitation on the number of apparatuses included in the information system A, and other apparatuses may also be included in the information system A.

In this embodiment, the information system A enables a user, who is a customer, to order an item at each seat in a so-called conveyor-belt sushi restaurant, for example. The store in which the information system A is used may be a restaurant of any other type of business or industry, and is not limited to restaurants. In addition, the information system A is not necessarily limited to be used in a real store, but may be used in a virtual store or a facility that provides a public service. In addition, the item provided to the user who ordered the item may be paid or free of charge.

In this example, the item may be tangible things or intangible things such as a service provided to a user.

In this example, the seat is a concept that means a seat or table to which the item is delivered. One seat corresponds to, for example, a customer group of one or at least two users who purchase an item (the customer group may include one or more users, and may be a single user). For example, when a customer group constituted by multiple users comes to a store that is a restaurant, and the customer group is guided to one table in the store, the one table corresponds to a seat. For example, when a customer group constituted by one user visits a restaurant, and the customer group is guided to a counter seat in the store, the counter seat corresponds to a seat. The term “seat” is not limited to an actual seat or table. The seat corresponds to a group constituted by one or more users, and may also be something else that indicates the group that purchased an item, the group that ordered an item, the group to which an item is to be delivered, or the like. Such a seat may be a real or virtual one. In other words, the seat is a concept that indicates a unit to which the items are provided and for which the items are charged.

In this embodiment, one customer group can place an order for an item or the like using one terminal apparatus 2 (a parent terminal apparatus) and one or more second terminal apparatuses 3 (child terminal apparatuses). For one customer group, which of the multiple terminal apparatuses functions as the terminal apparatus 2 and which of the others functions as the second terminal apparatus 3 may be set as described below and managed by the information processing apparatus 1. Hereafter, the terminal apparatus 2 and the second terminal apparatus 3 corresponding to one customer group may be collectively referred to as the terminal apparatuses 2 and 3.

In FIG. 1, for example, a portable information terminal apparatus such as a so-called smart phone, a tablet-type information terminal apparatus, and a personal computer (PC) such as a laptop computer are shown as a terminal apparatus 2 and a second terminal apparatus 3. Any of these may be used as the terminal apparatus 2 or the second terminal apparatus 3, or any other apparatus may be used. A user of the information system A (a user in the customer group) can use the information system A by using the terminal apparatus 2 or the second terminal apparatus 3. In the following examples, the description is based on the assumption that so-called smart phones are used as the terminal apparatus 2 and the second terminal apparatus 3, but there is no limitation to this.

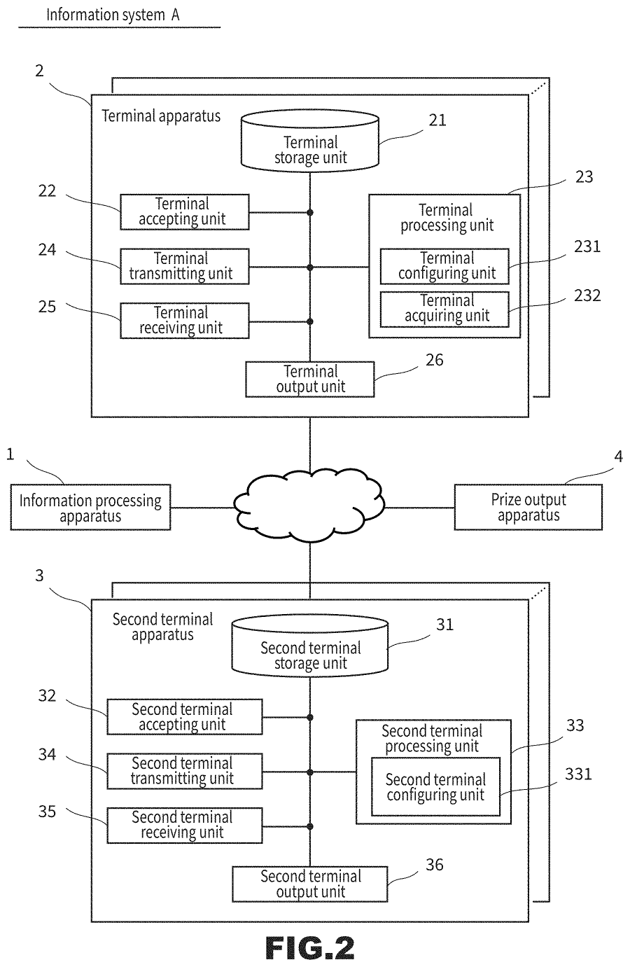

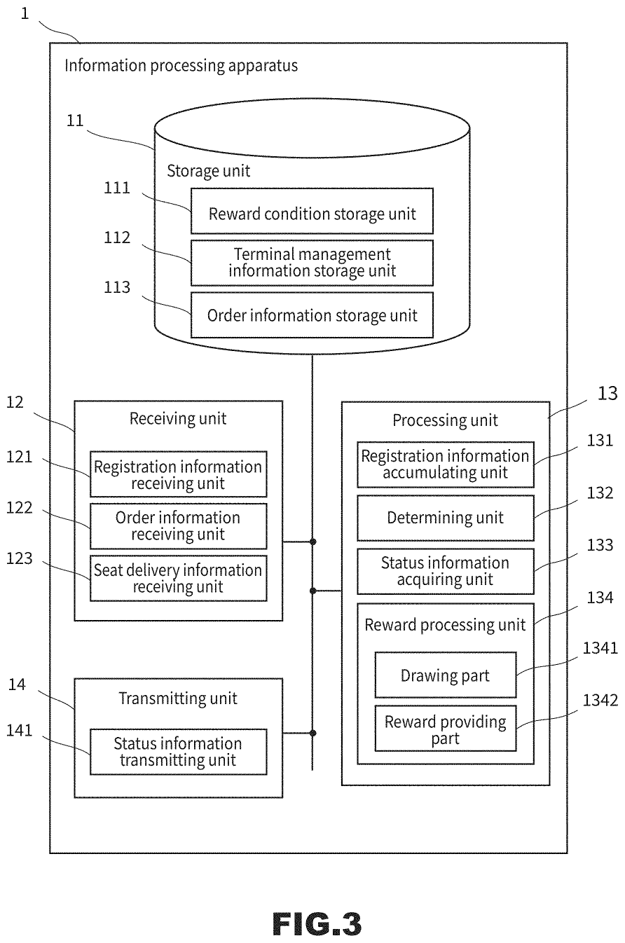

FIG. 2 is a block diagram of the information system Ain this embodiment. FIG. 3 is a block diagram of the information processing apparatus 1 in this embodiment.

As shown in FIG. 3, the information processing apparatus 1 includes a storage unit 11, a receiving unit 12, a processing unit 13, and a transmitting unit 14.

The information processing apparatus 1 is, for example, a server. The information processing apparatus 1 may be constituted by a single server, or multiple servers that operate in cooperation with each other. The information processing apparatus 1 may also be a computer or the like built into other apparatuses. It will be appreciated that the server may be a so-called cloud server, an ASP server, or the like, and there is no limitation on the type thereof.

The storage unit 11 includes a reward condition storage unit 111, a terminal management information storage unit 112, and an order information storage unit 113.

The storage unit 11 is preferably a non-volatile storage medium, but can also be realized by a volatile storage medium. For example, information and the like acquired by the units of the receiving unit 12 or the units of the processing unit 13 are stored in the units of the storage unit 11 as described later. There is no limitation on the procedure in which information is stored in the units of the storage unit 11. For example, information and the like may be stored in the storage unit 11 via a storage medium, information and the like transmitted via a communication line or the like may be stored in the storage unit 11, or information and the like input via an input device may be stored in the storage unit 11.

A reward condition for performing reward processing, which is processing that provides a reward, is stored in the reward condition storage unit 111.

The reward condition is, for example, a condition regarding the price of items purchased by the customer (e.g., 500 yen or more), a condition regarding the total number of items purchased by the customer (e.g., 10 items or more), or the like. The reward condition is, for example, set in advance and stored in the reward condition storage unit 111, but may be changed as needed. The reward condition may be set by the processing unit 13 or the like according to predetermined setting rules or the like according to various factors such as, for example, the season, time of day, weather conditions, the nature of the customer group (e.g., number of visits, number of persons, age, gender, etc.), the number of items in stock, and the degree of crowding of the store of the store. The reward condition may be set in response to information transmitted from another management apparatus (not shown) that can be communicated through a network.

Furthermore, the reward condition is, for example, a condition only regarding order information for predetermined one or more items out of two or more items. The reward condition may be, for example, information containing an item identifier for identifying an item that is subject to a reward, information containing an item identifier for identifying an item that is not subject to a reward, information containing an item type identifier for identifying the type of item that is subject to a reward, or information containing an item type identifier for identifying the type of item that is not subject to a reward.

Specifically, for example, a case is assumed in which the two or more items that can be ordered by a customer group include various types of sushi (e.g., “tuna”, “young yellowtail”, “salmon roe”, “egg”, etc.), beverages (e.g., “bottled beer (large)”, “bottled beer (small)”, “oolong tea”, “orange juice”, “drink bar”, etc.), side dishes (noodles (e.g., “kitsune udon”, “niku udon”, “shoyu ramen”, etc.), “hamburger”, etc.), and desserts (e.g., “pudding”, “vanilla ice cream”, “strawberry”, etc.). In this case, if noodles and beverages are defined as predetermined items out of the items that can be ordered by a customer group, only order information for beverages (e.g., “bottled beer (large)”, “bottled beer (small)”, “oolong tea”, “orange juice”, “drink bar”, etc.) or noodles (e.g., “kitsune udon”, “niku udon”, “shoyu ramen”, etc.) is relevant to the reward condition. For example, if only the item identifiers “kitsune udon”, “niku udon”, and “drink bar” are determined in advance out of the items that can be ordered by a customer group, only order information regarding these three items (e.g., order information containing any one of the item identifiers of the three items) is relevant to the reward condition. The predetermined one or more items may be determined from various perspectives. For example, as described below, an item that is not served on a plate that can be collected by a plate collecting apparatus (not shown) used with the prize output apparatus 4 may be defined as the predetermined one or more items. The predetermined one or more items may be changed as appropriate. For example, the predetermined one or more items may be set according to various factors such as, for example, the season, time of day, weather conditions, the nature of the customer group (e.g., number of visits, number of persons, age, gender, etc.), the number of items in stock, and the degree of crowding of the store. The predetermined one or more items may be set by the processing unit 13 or the like according to predetermined setting rules or the like. The predetermined one or more items may be set in response to information transmitted from another management apparatus (not shown) that can be communicated through a network.

The reward processing includes, for example, transmission processing of a prize output instruction to the prize output apparatus 4 for outputting a prize. The prize output instruction is an instruction to cause the prize output apparatus 4 to output a prize. That is to say, it can be said that the reward processing includes reward providing processing that provides a prize to a customer group. In this embodiment, the reward processing includes, for example, drawing processing that determines a drawing result of a customer group. The reward processing is, for example, processing that provides a prize by performing reward providing processing for a customer group which was selected as a winner as a result of drawing processing. It can be considered that the customer group is the same as the seat.

In this embodiment, in the case in which a settlement (payment for an item) is made, the order information of the seat is reset. In the case in which reward processing is performed and a reward is provided, the order information of the seat becomes irrelevant to the reward processing, but there is no limitation to this.

One or more pieces of terminal management information are stored in the terminal management information storage unit 112. The terminal management information is information having a seat identifier, one or at least two terminal identifiers, and parent-child distinguishing information. The seat identifier is an identifier for uniquely identifying a seat. The terminal identifiers are identifiers for uniquely identifying the terminal apparatuses 2 and 3. The parent-child distinguishing information is information for distinguishing one terminal apparatus 2 serving as a parent apparatus from one or more child terminal apparatuses (second terminal apparatuses 3). The parent-child distinguishing information is, for example, a flag added to a terminal apparatus 2 serving as a parent apparatus, a flag added to a second terminal apparatus 3 serving as a child apparatus, or a terminal identifier of the terminal apparatus 2 serving as a parent apparatus. In other words, the terminal management information is information for specifying a terminal apparatus 2 and a second terminal apparatus 3 associated with one seat. The order in which the terminal identifiers are stored in the terminal management information may be information for distinguishing a parent apparatus from a child terminal apparatus. For example, if the terminal management information has a seat identifier and two or more terminal identifiers, processing may be performed while taking a first terminal identifier in the storage area of the terminal management information as an identifier of a terminal apparatus 2 serving as a parent apparatus and taking second and subsequent stored terminal identifiers as identifiers of second terminal apparatuses 3 serving as child apparatuses. In this case, the parent-child distinguishing information does not exist explicitly, but since a parent terminal apparatus and a child terminal apparatus can be distinguished from each other, the terminal management information may be considered to have the parent-child distinguishing information. That is to say, the terminal management information may be considered to have the parent-child distinguishing information if a parent terminal apparatus and a child terminal apparatus can be distinguished from each other.

Order information received by an order information receiving unit 122 is stored in the order information storage unit 113. The order information is information regarding an order for an item, information having seat specifying information for specifying a seat, and information transmitted from the terminal apparatuses 2 and 3. The seat specifying information is a seat identifier or a terminal identifier. In the case in which the seat specifying information is a terminal identifier, the order information can be associated with the seat identifier by managing the terminal identifier and the seat identifier in association with each other. That is to say, in this embodiment, an order for an item is placed at each seat, and the order information is stored in the information processing apparatus 1. In other words, in this embodiment, a user in a customer group can order an item for each customer group.

The order information has, for example, an item identifier for uniquely identifying an item. The order information has, for example, an item identifier and the number of items ordered. The order information may have, for example, an item identifier and a price.

Typically, two or more pieces of item management information each having an item identifier and a unit price are stored in the storage unit 11 of the information processing apparatus 1. The item management information is, for example, a database in which an item identifier and its unit price are recorded in association with each other. The item management information may be stored in other apparatuses. With such item management information, the unit price for the item identifier contained in the order information can be identified. That is to say, the price corresponding to the item identifier contained in the order information can be calculated.

The order information may be, for example, information indicating that a plate on which an item is placed has been served (delivered) to a customer group. In other words, the order information may be post-order information.

The receiving unit 12 includes a registration information receiving unit 121, an order information receiving unit 122, and a seat delivery information receiving unit 123.

The receiving unit 12 is typically realized by a wired or wireless communication part, but may also be realized by a broadcast receiving part.

The registration information receiving unit 121 receives registration information from one or at least two terminal apparatuses 2 and 3. The registration information is information for associating a seat with the terminal apparatuses 2 and 3. The registration information has terminal identifiers of the terminal apparatuses 2 and 3. The registration information is information having terminal identifiers of the terminal apparatuses 2 and 3 and a seat identifier of a seat corresponding to the terminal apparatuses 2 and 3 (a seat corresponding to a customer group that owns the terminal apparatuses 2 and 3).

The order information receiving unit 122 receives one or more pieces of order information transmitted from the terminal apparatuses 2 and 3. In this embodiment, for example, the order information receiving unit 122 receives order information having seat specifying information corresponding to a same seat, from two or more terminal apparatuses 2 and 3 associated with the same seat. The order information receiving unit 122 accumulates the received order information in the order information storage unit 113.

In this embodiment, the order information receiving unit 122 is configured to also receive one or more pieces of second order information, each of which is information having a seat identifier and is order information transmitted from an apparatus different from the terminal apparatuses 2 and 3. For example, the second order information is information transmitted from an order input apparatus that has been installed in the store associated with the seat in advance. The customer group can order an item by transmitting the second order information to the information processing apparatus 1 using the order input apparatus installed in the store, even without using the terminal apparatuses 2 and 3. The order information receiving unit 122 may also be able to accumulate the received second order information in the order information storage unit 113. For example, the second order information may be information transmitted from an unshown operation terminal of a staff member. Also, for example, the second order information may be information indicating that a plate has been collected by an unshown plate collecting apparatus. Such second order information may be, for example, trigger information indicating that a plate has been collected, or information indicating the number of plates. Also in such a case, if the price of a plate is fixed (e.g., 100 yen), the second order information can be used to calculate the price.

Furthermore, in this embodiment, it is preferable that the order information receiving unit 122 receives cancellation information transmitted from the terminal apparatuses 2 and 3 or the like. The cancellation information may be received from a terminal or the like held by a staff member. The cancellation information has, for example, seat specifying information and an item identifier, but there is no limitation to this. For example, the cancellation information may have an identifier specifying order information.

The seat delivery information receiving unit 123 receives seat delivery information indicating that an item identified with an item identifier contained in order information has been delivered to a seat. The seat delivery information is information having a seat identifier and an item identifier. The receiving seat delivery information contains, for example, receiving information from an item conveying instructing apparatus (e.g., an ordered item management terminal in a kitchen, etc.) that is an unshown apparatus, or an item conveying apparatus (e.g., an apparatus having a conveyor belt on which sushi plates go around, etc.) that conveys an item to a seat. In this example, the item being delivered to a seat is a concept that encompasses not only actually delivering the item to the seat, but also placing the onto item conveying apparatus, and instructing the item conveying instructing apparatus to convey the item. The seat delivery information may be transmitted by a store staff member or the like performing an operation indicating that an item has been delivered to a seat, to an operation terminal, but there is no limitation to this. For example, the seat delivery information may be transmitted by a customer group reporting that an item has been delivered to a seat, using the terminal apparatuses 2 and 3 or the like. For example, the seat delivery information may be transmitted in the case in which an apparatus installed in the store detects that there is an item delivered to a seat (e.g., that an item is on the table of the seat) or that an item has been placed on an item conveyor.

The processing unit 13 includes a registration information accumulating unit 131, a determining unit 132, a status information acquiring unit 133, and a reward processing unit 134.

The processing unit 13 may be realized typically by an MPU, a memory, or the like. Typically, the processing procedure of the processing unit 13 is realized by software, and the software is stored in a storage medium such as a ROM. Note that the procedure may be realized also by hardware (dedicated circuits). The processing unit 13 performs various types of processing. The various types of processing are, for example, processing that is performed by the units of the processing unit 13 as follows.

In the case in which the order information receiving unit 122 receives order information, the processing unit 13 performs order processing. That is to say, the processing unit 13 receives an order for an item identified with an item identifier contained in the order information, with respect to a seat specified with seat specifying information contained in the order information. The number of ordered items is the number designated in the order information. Accordingly, the store starts preparations to deliver the ordered item, to the seat.

Furthermore, in the case in which cancellation information is received, the processing unit 13 performs cancellation processing. That is to say, in the cancellation processing, the processing unit 13 cancels the corresponding order and deletes the corresponding order information stored in the order information storage unit 133. Note that the processing unit 13 may record information indicating that the order has been cancelled, in association with the order information.

The registration information accumulating unit 131 configures terminal management information by associating a terminal identifier contained in the registration information received by the registration information receiving unit 121 with a seat identifier contained in the registration information received by the registration information receiving unit 121, and accumulates it in the terminal management information storage unit 112. That is to say, the registration information accumulating unit 131 performs terminal registration processing. The terminal registration processing will be described later in detail. The terminal management information may contain parent-child distinguishing information. The parent-child distinguishing information is information for distinguishing whether the terminal apparatus 2, 3 indicated by the terminal identifier that is associated with the seat identifier is a parent apparatus or a child apparatus. The parent-child distinguishing information may be information associated only with the terminal identifier of the terminal apparatus 2 serving as a parent apparatus or only with the terminal identifier of the second terminal apparatus 3 serving as a child apparatus.

The determining unit 132 determines whether or not one or more pieces of order information received by the order information receiving unit 122 and corresponding to one seat identifier for identifying a seat (which may correspond to a seat identifier corresponding to seat specifying information) one or more pieces of order information match the reward condition stored in the reward condition storage unit 111. The processing that performs this determination may be referred to as reward determination processing. The determining that order information matches the reward condition means that the procedure is allowed to advance to the reward processing, and the determining that order information does not match the reward condition means that the procedure is not allowed to advance to the reward processing. In this embodiment, the determining unit 132 determines whether or not two or more pieces of order information with a same seat identifier that is paired with a terminal identifier, which is seat specifying information contained in the order information match the reward condition. That is to say, the determining unit 132 determines, for each seat, whether or not two or more pieces of order information corresponding to that seat match the reward condition. In other words, the determining unit 132 determines, for each customer group, whether or not order information based on two or more orders of that customer group matches the reward condition.

In this embodiment, it is preferable that order information that is subject to the determination as to whether or not the order information matches the reward condition is limited to the order information for which an item has already been delivered. That is to say, it is preferable that the determining unit 132 determines whether or not one or more pieces of order information corresponding to a seat identifier contained in the seat delivery information received by the seat delivery information receiving unit 123 and further corresponding to an item identifier contained in the seat delivery information match the reward condition. With this processing, it is possible to cancel the order for the ordered item before the item is delivered, which is beneficial to the customer.

Furthermore, in the case in which the order information receiving unit 122 receives second order information, it is preferable that order information that is subject to the determination as to whether or not the order information matches the reward condition includes order information transmitted from the terminal apparatuses 2 and 3 and second order information corresponding to the same seat. That is to say, in the case in which the order information receiving unit 122 receives second order information, it is preferable that the determining unit 132 determines whether or not one or more pieces of order information transmitted from the terminal apparatuses 2 and 3 and one or more pieces of second order information corresponding to a same seat identifier as that of the one or more pieces of order information match the reward condition.

The status information acquiring unit 133 acquires status information using a determination result of the reward determination processing by the determining unit 132. The status information is information related to one or more pieces of order information corresponding to the one seat identifier and a reward condition, and is information regarding an ordering status. In this example, the determination result of the determining unit 132 is, for example, a determination result indicating that the procedure is allowed to advance to the reward processing or a determination result indicating that the procedure is not allowed to advance to the reward processing. The status information is information indicating that the procedure is allowed to advance to the reward processing, information regarding remaining orders necessary to advance the procedure to the reward processing, information indicating the total price or the total number of items ordered to advance the procedure to the reward processing, or the like. More specifically, the status information is screen information indicating that the procedure is allowed to advance to the reward processing, user interface component information visually indicating remaining orders necessary to advance the procedure to the reward processing, or the like. That is to say, the acquiring status information using a determination result of the determining unit 132 is, for example, acquiring screen information indicating that the procedure is allowed to advance to the reward processing in response to a determination result of the determining unit 132 indicating that the procedure is allowed to advance to the reward processing, acquiring user interface component information visually indicating remaining orders necessary to advance the procedure to the reward processing in response to a determination result of the determining unit 132 indicating that the procedure is not allowed to advance to the reward processing, or the like. The user interface component information is preferably information of graphical UI components such as bars and graphs, for example, but may also be a character string or the like, there is no limitation on the data format thereof.

The reward processing unit 134 in this embodiment includes a drawing part 1341 and a reward providing part 1342.

In the case in which the determining unit 132 determines that order information matches the reward condition, the reward processing unit 134 performs the reward processing on a seat identified with one seat identifier. As described above, the reward processing includes, for example, drawing processing and reward providing processing. Note that the reward processing unit 134 may perform only reward providing processing.

The drawing part 1341 performs drawing processing that determines whether or not each customer group is a winner and to be provided with a reward. The drawing processing can be performed using various methods. For example, a winner may be randomly determined using a pseudo-random number, or a winner may be determined each time a predetermined number of drawings are conducted so that a winner is selected with a predetermined probability for each customer group. The drawing processing may be performed in the case in which an instruction from a user is input through the terminal apparatuses 2 and 3, or may be performed regardless of the presence or absence of such an instruction from a user.

The reward providing part 1342 performs reward providing processing that provides a reward to a seat identified with one seat identifier. The reward providing processing is, for example, processing that transmits a prize sending instruction to the prize output apparatus 4. More specifically, for example, it is processing that transmits a prize sending instruction, thereby opening an item port of the prize output apparatus 4 and allowing one prize to be output from the prize output apparatus 4.

The transmitting unit 14 includes a status information transmitting unit 141.

The transmitting unit 14 is typically realized by a wired or wireless communication part, but may also be realized by a broadcast receiving part. Since the receiving unit 12 and the transmitting unit 14 are provided, the information processing apparatus 1 is connected to a network and can communicate with other apparatuses connected to the network.

The status information transmitting unit 141 transmits status information acquired by the status information acquiring unit 133, to the terminal apparatus 2. In this embodiment, the order information is also transmitted from the second terminal apparatus 3 serving as a child apparatus, but also in the case in which the status information is accordingly acquired, the destination of the status information is limited to the terminal apparatus 2 serving as a parent apparatus. That is to say, the status information transmitting unit 141 transmits status information only to the terminal apparatus 2 serving as a parent apparatus specified with the parent-child distinguishing information. The status information transmitting unit 141 typically transmits status information only to the terminal apparatus 2 serving as a parent apparatus, using the terminal identifier of the terminal apparatus 2 serving as a parent apparatus specified with the parent-child distinguishing information. Accordingly, only the terminal apparatus 2 serving as a parent apparatus can confirm information regarding providing a reward and make an instruction from a customer group side. Thus, it is possible to prevent the status information displayed by the terminal apparatus 2 and the second terminal apparatus 3 from being different and the multiple instructions from the customer group from being complicated on the information processing apparatus 1 side. Note that the configuration is not limited to this, and the information may be transmitted to the second terminal apparatus 3, or the status information may be transmitted to both the terminal apparatus 2 and the second terminal apparatus 3 corresponding to the same seat identifier.

With respect to the transmission of the status information by the status information transmitting unit 141, the status information to be transmitted may be different between cases in which the determining unit 132 gives a determination result indicating that order information matches the reward condition and a determination result indicating that order information does not match the reward condition. Also, the status information may be transmitted only in the case in which it is determined that the determination result of the determining unit 132 indicates that order information matches the reward condition.

Next, other apparatuses of the information system A will be described.

As shown in FIG. 2, the terminal apparatus 2 includes a terminal storage unit 21, a terminal accepting unit 22, a terminal processing unit 23, a terminal transmitting unit 24, a terminal receiving unit 25, and a terminal output unit 26. The terminal apparatus 2 is, for example, a general smart phone and has a display device with a touch panel, but there is no limitation to this. The terminal apparatus 2 can be connected to a network and can communicate with other apparatuses connected to the network.

The terminal storage unit 21 is preferably a non-volatile storage medium, but can also be realized by a volatile storage medium. Various types of information, programs, and the like are stored in the terminal storage unit 21. There is no limitation on the procedure in which such information and the like are stored. For example, the information may be stored in the terminal storage unit 21 via a storage medium, the information transmitted via a communication line or the like may be stored in the terminal storage unit 21, or the information input via an input device may be stored in the terminal storage unit 21.

In this embodiment, seat specifying information is stored in the terminal storage unit 21. In the case in which the seat specifying information is a terminal identifier, the information processing apparatus 1 can specify a seat based on information in which the terminal identifier and the seat identifier managed by the information processing apparatus 1 are associated with each other. On the other hand, in the case in which the seat specifying information is a seat identifier, it is sufficient that a seat identifier of a seat corresponding to the terminal apparatus 2 is acquired in advance by the terminal processing unit 23 or the like, and the acquired seat identifier is accumulated in the terminal storage unit 21. A seat identifier may be acquired, for example, by reading an image such as a two-dimensional code prepared in advance at a store or the like in association with the seat using an unshown camera, or by a user inputting the seat identifier and corresponding information to the terminal apparatus 2. The seat identifier may also be transmitted from the seat to the terminal apparatus 2 by wireless communication or the like.

Furthermore, child apparatus authentication information for authenticating one or more second terminal apparatuses 3 serving as child apparatuses is stored in the terminal storage unit 21. The child apparatus authentication information is, for example, a seat identifier, a terminal identifier of the terminal apparatus 2, or information corresponding to these identifiers, but there is no limitation to this. The child apparatus authentication information may be a two-dimensional code, a bar code, or the like representing the above information. The child apparatus authentication information may be generated in advance and stored in the terminal storage unit 21, or may be generated dynamically by the terminal processing unit 23 or the like and temporarily stored in the terminal storage unit 21.

The terminal accepting unit 22 accepts an ordering instruction having an item identifier, in response to an operation for ordering an item by a user of the terminal apparatus 2. The operation for ordering an item is performed, for example, on a predetermined menu screen output by the terminal output unit 26 to an unshown display device, but there is no limitation to this.

Furthermore, in this embodiment, the terminal accepting unit 22 accepts a terminal reward instruction, which is an instruction from a user of the terminal apparatus 2 to advance the procedure to the reward processing. The terminal reward instruction is an instruction to the screen information output by the terminal output unit 26 according to status information acquired by a terminal acquiring unit 232.

The terminal processing unit 23 includes a terminal configuring unit 231 and a terminal acquiring unit 232.

The terminal processing unit 23 may be realized typically by an MPU, a memory, or the like. Typically, the processing procedure of the terminal processing unit 23 is realized by software, and the software is stored in a storage medium such as a ROM. Note that the procedure may be realized also by hardware (dedicated circuits).

The terminal configuring unit 231 configures order information containing the item identifier contained in the ordering instruction and the seat specifying information, in response to an ordering instruction accepted by the terminal accepting unit 22. The terminal configuring unit 231 accumulates the configured order information, for example, in the terminal storage unit 21.

The terminal acquiring unit 232 acquires status information for reward processing. Note that the status information is typically transmitted by the status information transmitting unit 141 of the information processing apparatus 1, but may also be constituted by order information in the terminal apparatus 2. For example, in the case in which the order information is transmitted by the terminal transmitting unit 24, the status information may be accordingly received. The terminal acquiring unit 232 accumulates the acquired status information, for example, in the terminal storage unit 21.

The terminal transmitting unit 24 is typically realized by a wired or wireless communication part, but may also be realized by a broadcasting part. The terminal transmitting unit 24 reads the order information configured by the terminal configuring unit 231, from the terminal storage unit 21 or the like, and transmits the order information. The order information is typically transmitted to the information processing apparatus 1.

Furthermore, in this embodiment, in the case in which the terminal reward instruction is accepted by the terminal accepting unit 22, the terminal transmitting unit 24 accordingly transmits a reward instruction, which is an instruction to perform reward processing. The reward instruction is typically transmitted to the information processing apparatus 1, but may be transmitted to, for example, the prize output apparatus 4 or the like.

The terminal receiving unit 25 is typically realized by a wired or wireless communication part, but may also be realized by a broadcast receiving part. The terminal receiving unit 25 receives information transmitted from the information processing apparatus 1 or other apparatuses via a network. The terminal receiving unit 25 accumulates the received information, for example, in the terminal storage unit 21, so that the terminal processing unit 23 or the like can acquire it.

The terminal output unit 26 outputs the information by, for example, displaying it on a display device. Note that the method of outputting the information is not limited to this, and the information may be output by, for example, outputting voice or the like from a speaker or the like. The terminal output unit 26 outputs, for example, an order screen for ordering an item based on the information stored in the terminal storage unit 21. Accordingly, a user of the terminal apparatus 2 can give an ordering instruction using the terminal apparatus 2. Note that the order screen information for outputting the order screen may be, for example, received in advance from the information processing apparatus 1 and stored in the terminal storage unit 21, or may be received from the information processing apparatus 1 at any time when the order screen is output and stored in the terminal storage unit 21.

In this embodiment, the terminal output unit 26 reads the status information acquired by the terminal acquiring unit 232 from the terminal storage unit 21, and outputs the status information. Through the output of the status information, the user can know the status regarding the reward processing, and can give a terminal reward instruction in the case in which a terminal reward instruction can be given.

Furthermore, the terminal output unit 26 outputs the child apparatus authentication information stored in the terminal storage unit 21 in the case in which a predetermined condition is satisfied. In this embodiment, child apparatus authentication information is output in the case in which the terminal accepting unit 22 accepts a child apparatus authentication instruction. The case in which the terminal accepting unit 22 accepts a child apparatus authentication instruction is, for example, a case in which a predetermined operation is accepted by a user, or a case in which the terminal receiving unit 25 receives predetermined instruction information transmitted from the information processing apparatus 1 or the like, for example. The child apparatus authentication information is output using various methods such as, for example, displaying a character string or an image indicating the child apparatus authentication information on a display device, outputting voice, or transmitting via wireless communication (e.g., RFID, etc.). It is sufficient that the child apparatus authentication information is output so that it can be obtained by the second terminal apparatus 3 serving as a child apparatus.

In this embodiment, in the case in which the terminal apparatus 2 is used as a parent terminal apparatus of a customer group, for example, the registration information may be transmitted to the information processing apparatus 1 as follows. That is to say, the terminal processing unit 23 acquires a seat identifier of a seat corresponding to the terminal apparatus 2, and configures registration information by associating the acquired seat identifier with the terminal identifier of the terminal apparatus 2. The seat identifier may be acquired as described above. Then, the terminal transmitting unit 24 transmits the configured registration information to the information processing apparatus 1. Accordingly, thereafter, the information processing apparatus 1 can process the order information (which includes the terminal identifier as the seat specifying information) transmitted from the terminal apparatus 2 as being an order for a specific seat.

The second terminal apparatus 3 includes a second terminal storage unit 31, a second terminal accepting unit 32, a second terminal processing unit 33, a second terminal transmitting unit 34, a second terminal receiving unit 35, and a second terminal output unit 36. As in the case of the terminal apparatus 2, the second terminal apparatus 3 is, for example, a general smart phone and has a display device with a touch panel, but there is no limitation to this. The second terminal apparatus 3 can be connected to a network and can communicate with other apparatuses connected to the network.

The second terminal storage unit 31 is preferably a non-volatile storage medium, but can also be realized by a volatile storage medium. Various types of information, programs, and the like are stored in the second terminal storage unit 31. There is no limitation on the procedure in which such information and the like are stored. For example, the information may be stored in the second terminal storage unit 31 via a storage medium, the information transmitted via a communication line or the like may be stored in the second terminal storage unit 31, or the information input via an input device may be stored in the second terminal storage unit 31.

A terminal identifier of the second terminal apparatus 3 (hereinafter, in particular, the terminal identifier of the second terminal apparatus 3 is referred to as the second terminal identifier and may be distinguished from the terminal identifier of the terminal apparatus 2) is stored in the second terminal storage unit 31. Seat specifying information is stored in the second terminal storage unit 31. In the case in which the seat specifying information is a second terminal identifier, the information processing apparatus 1 can specify a seat based on information in which the second terminal identifier and the seat identifier managed by the information processing apparatus 1 are associated with each other. In the case in which the seat specifying information is a seat identifier, it is sufficient that a seat identifier of a seat corresponding to the second terminal apparatus 3 is acquired in advance by the second terminal processing unit 33 or the like, and the acquired seat identifier is accumulated in the second terminal storage unit 31. That is to say, it is sufficient that a seat identifier of a seat corresponding to the terminal apparatus 2 serving as a parent apparatus of the second terminal apparatus 3 is acquired, and the acquired seat identifier is accumulated in the second terminal storage unit 31. A seat identifier may be acquired, for example, as in the case of the terminal apparatus 2 described above.

The second terminal accepting unit 32 accepts an ordering instruction having an item identifier, in response to an operation for ordering an item by a user of the second terminal apparatus 3, in the case in which an order screen is displayed as described below. The operation for ordering an item is performed, for example, on a predetermined menu screen output by the second terminal output unit 36 to an unshown display device, but there is no limitation to this.

The second terminal processing unit 33 includes a second terminal configuring unit 331.

The second terminal processing unit 33 may be realized typically by an MPU, a memory, or the like. Typically, the processing procedure of the second terminal processing unit 33 is realized by software, and the software is stored in a storage medium such as a ROM. Note that the procedure may be realized also by hardware (dedicated circuits).

The second terminal configuring unit 331 configures order information containing the item identifier contained in the ordering instruction and the seat specifying information, in response to an ordering instruction accepted by the second terminal accepting unit 32. The second terminal configuring unit 331 accumulates the configured order information, for example, in the second terminal storage unit 31.

The second terminal transmitting unit 34 is typically realized by a wired or wireless communication part, but may also be realized by a broadcasting part. The second terminal transmitting unit 34 reads the order information configured by the second terminal configuring unit 331, from the second terminal storage unit 31 or the like, and transmits the order information. The order information is typically transmitted to the information processing apparatus 1.

The second terminal receiving unit 35 is typically realized by a wired or wireless communication part, but may also be realized by a broadcast receiving part. The second terminal receiving unit 35 receives information transmitted from the information processing apparatus 1 or other apparatuses via a network. The second terminal receiving unit 35 accumulates the received information, for example, in the second terminal storage unit 31, so that the second terminal processing unit 33 or the like can acquire it.

The second terminal output unit 36 outputs the information by, for example, displaying it on a display device. Note that the method of outputting the information is not limited to this, and the information may be output by, for example, outputting voice or the like from a speaker or the like. The second terminal output unit 36 outputs, for example, an order screen for ordering an item based on the information stored in the second terminal storage unit 31. Accordingly, a user of the second terminal apparatus 3 can give an ordering instruction using the second terminal apparatus 3.

In this embodiment, the second terminal apparatus 3 acquires child apparatus authentication information output by the terminal apparatus 2 serving as a parent apparatus as follows, thereby serving as a child apparatus of the terminal apparatus 2.

That is to say, first, the second terminal accepting unit 32 accepts the child apparatus authentication information output by the terminal apparatus 2. That is to say, for example, in the case in which child apparatus authentication information is displayed as an image such as a two-dimensional code on by a display device or the like of the image terminal apparatus 2, the second terminal accepting unit 32 acquires the child apparatus authentication information by reading it using an unshown camera. Also, the child apparatus authentication information may be acquired by the user inputting the child apparatus authentication information and corresponding information to the second terminal apparatus 3. Also, the child apparatus authentication information may be transmitted from the terminal apparatus 2 to the second terminal apparatus 3 by wireless communication or the like.

In the case in which the child apparatus authentication information is accepted in this manner, the second terminal transmitting unit 34 transmits registration information having a second terminal identifier and a seat identifier, in response to acceptance of the child apparatus authentication information, to the information processing apparatus 1. Note that the registration information may be information having a second terminal identifier and a terminal identifier of the terminal apparatus 2 serving as a parent apparatus. That is to say, the registration information may be any information, for example, such as a combination of a second terminal identifier and seat specifying information, with which a relationship between the terminal apparatus 2 serving as a parent apparatus, the second terminal apparatus 3 serving as a child apparatus, and the seat (the customer group) can be specified by the information processing apparatus 1.

In the case in which the registration information is transmitted to the information processing apparatus 1 in this manner, the information processing apparatus 1 can specify that the terminal apparatus 2 is a parent apparatus, the second terminal apparatus 3 is its child apparatus, and the terminal apparatus 2 and the second terminal apparatus 3 correspond to a specific seat. Upon receiving registration information transmitted from the second terminal apparatus 3, the information processing apparatus 1 transmits order screen information for outputting the order screen for two or more items, to the second terminal apparatus 3.

The second terminal receiving unit 35 receives the order screen information transmitted from the information processing apparatus 1, and accumulates it in the second terminal storage unit 31. Accordingly, second the terminal output unit 26 can output the order screen using the order screen information. In the case in which an ordering instruction is accepted by the second terminal apparatus 3 and order information is transmitted to the information processing apparatus 1, the order information, together with the order information by the terminal apparatus 2 serving as a parent apparatus and other second terminal apparatuses 3 serving as child apparatuses of the terminal apparatus 2, is treated as being an order corresponding to the same seat.

In this embodiment, the second terminal accepting unit 32 does not receive a terminal reward instruction, contrary to the terminal accepting unit 22 of the terminal apparatus 2. Furthermore, reception of the status information and output of the status information are not performed by the second terminal apparatus 3. Accordingly, even in the case in which multiple users in one customer group place orders using the terminal apparatuses 2 and 3, information and operations regarding reward processing are collectively accepted by the terminal apparatus 2 serving as a parent apparatus. Thus, inconsistency of information regarding reward processing does not occur among the apparatuses constituting the information system A.

The prize output apparatus 4 has a mechanical structure similar to, but not limited to, a prize ejecting mechanism used with a plate collecting apparatus as described in Japanese Patent No. 3859962. In this embodiment, the prize output apparatus 4 is configured to, upon receiving a prize output instruction transmitted from another apparatus via a network, output a prize in response to the instruction. Note that the prize is not limited to tangible things, but may be a coupon code exchangeable for an item or other tangible things, a point, or the like. The outputting a prize may be passing a thing from the prize output apparatus 4 to a user. The outputting a prize may also be displaying information on a display device provided on the prize output apparatus 4 or the like, or transmitting information to a terminal apparatus 2 or the like owned by a user.

Example of Processing Flow of Information System A

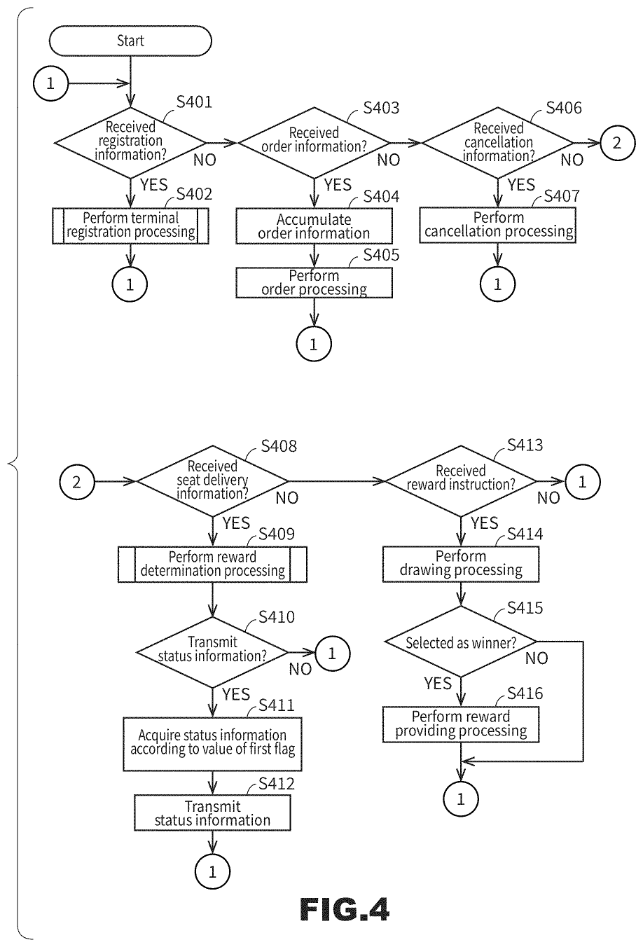

FIG. 4 is a flowchart showing an example of an operation of the information processing apparatus 1.

In this embodiment, the information processing apparatus 1 operates as follows.

(Step S401) The registration information receiving unit 121 determines whether or not it has received registration information. If it has received receive registration information, the procedure advances to step S402, or otherwise the procedure advances to step S403.

(Step S402) The registration information accumulating unit 131 performs terminal registration processing. The terminal registration processing will be described later in detail. Subsequently, the procedure returns to step S401.

(Step S403) The order information receiving unit 122 determines whether or not it has received order information. If it has received order information, the procedure advances to step S404, or otherwise the procedure advances to step S406.

(Step S404) The order information receiving unit 122 accumulates the received order information in the order information storage unit 113.

(Step S405) The processing unit 13 performs order processing as described above, in response to the order information received by the order information receiving unit 122. Accordingly, the store starts preparations to deliver the ordered item, to the seat.

(Step S406) The order information receiving unit 122 determines whether or not it has received cancellation information indicating that an order is to be cancelled. If it has received cancellation information, the procedure advances to step S407, or otherwise the procedure advances to step S408.

(Step S407) The processing unit 13 performs cancellation processing as described above, in response to the cancellation information received by the order information receiving unit 122. Accordingly, the order is cancelled without causing any effect on the reward processing.

(Step S408) The seat delivery information receiving unit 123 determines whether or not it has received seat delivery information. If it has received seat delivery information, the procedure advances to step S409, or otherwise the procedure advances to step S413.

(Step S409) The determining unit 132 performs reward determination processing. The reward determination processing will be described later in detail.

(Step S410) The determining unit 132 determines whether or not to transmit status information, according to a result of the reward determination processing. Specifically, if a second flag in later-described reward determination processing indicates “there is a status change”, it is determined that status information is to be transmitted. If it is determined that status information is to be transmitted, the procedure advances to step S411, or otherwise the procedure returns to step S401.

(Step S411) The status information acquiring unit 133 acquires status information, according to a result of the reward determination processing. Specifically, as described later, status information is acquired according to a value of a first flag.

(Step S412) The status information transmitting unit 141 transmits the status information acquired by the status information acquiring unit 133. Subsequently, the procedure returns to step S401.

(Step S413) The reward processing unit 134 determines whether or not it has received a reward instruction. If it is determined that it has received a reward instruction, the procedure advances to step S414. That is to say, the reward processing is started. If not, the procedure returns to step S401.

(Step S414) The drawing part 1341 performs drawing processing.

(Step S415) The drawing part 1341 determines whether or not the customer group was selected as a winner. If it is determined that the customer group was selected as a winner, the procedure advances to step S416, or otherwise the procedure returns to step S401.

(Step S416) The reward providing part 1342 performs reward providing processing. That is to say, the reward providing part 1342 transmits a prize sending instruction to the prize output apparatus 4. Accordingly, one prize is output from the prize output apparatus 4. That is to say, the customer group is provided with a reward. Subsequently, the procedure returns to step S401.

For example, this series of processing is ended in the case in which the system of the information processing apparatus 1 is ended, for example.

For example, in the above-described series of processing, the processing after the reward determination processing may be performed regardless of whether or not seat delivery information is received, after order information is received. In this case, whether the reward determination processing is performed regardless of whether or not seat delivery information is received, or is not performed until seat delivery information is received may be changed according to the ordered item or other conditions. For example, in the case in which a reward instruction is received, the reward providing processing may be directly performed without performing the drawing processing.

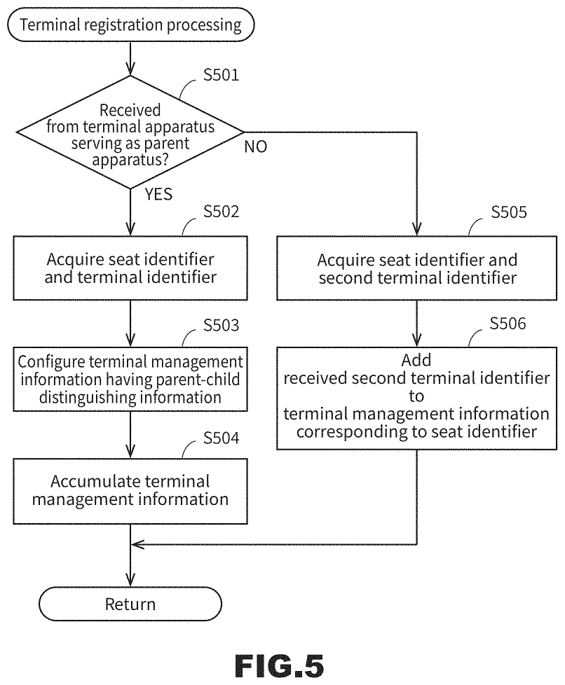

FIG. 5 is a flowchart showing an example of terminal registration processing in this embodiment.

(Step S501) The registration information accumulating unit 131 determines whether or not it has received registration information received by the registration information receiving unit 121, from the terminal apparatus 2 serving as a parent apparatus. If it is determined that it has received registration information from the terminal apparatus 2 serving as a parent apparatus, the procedure advances to step S502. If not, the procedure advances to step S505.

The above-described determination may be performed, for example, according to whether registration information containing a seat identifier and a terminal identifier has been received or registration information containing a terminal identifier of a parent apparatus and a terminal identifier (second terminal identifier) different therefrom has been received. For example, in the case in which registration information containing a seat identifier and a terminal identifier has been received, the registration information accumulating unit 131 may determine that the information has been transmitted from the terminal apparatus 2 serving as a parent apparatus. In the case in which registration information containing a terminal identifier and a second terminal identifier has been received, the registration information accumulating unit 131 may determine that the information has not been transmitted from the terminal apparatus 2 serving as a parent apparatus (has been transmitted from the second terminal apparatus 3 serving as a child apparatus). Note that the determination method is not limited thereto, and, for example, the determination may be performed based on whether or not registration information has been received containing a flag indicating that transmission was made from the terminal apparatus 2 serving as a parent apparatus. Furthermore, in the case in which there is a seat for which a terminal apparatus 2 or 3 has not yet been registered, when registration information containing a seat identifier of that seat and terminal identifier is newly received, it may be determined that the registration information has been transmitted from the terminal apparatus 2 serving as a parent apparatus.

(Step S502) The registration information accumulating unit 131 acquires a seat identifier and a terminal identifier from the registration information.

(Step S503) The registration information accumulating unit 131 configures terminal management information having parent-child distinguishing information. That is to say, a terminal identifier and information indicating that the terminal identifier is an identifier of the terminal apparatus 2 serving as a parent apparatus are associated with a seat identifier.

(Step S504) The registration information accumulating unit 131 accumulates the configured terminal management information in the terminal management information storage unit 112. Subsequently, the procedure returns to the processing in FIG. 4.

(Step S505) On the other hand, if it is not determined registration information has been received from the terminal apparatus 2 serving as a parent apparatus, the registration information accumulating unit 131 acquires a seat identifier based on the received registration information. The registration information accumulating unit 131 acquires a second terminal identifier contained in the received registration information.

(Step S506) The registration information accumulating unit 131 adds the received second terminal identifier to terminal management information corresponding to the seat identifier stored in the terminal management information storage unit 112. Accordingly, the second terminal apparatus 3 serving as a child apparatus is managed while being associated with a seat. Subsequently, the procedure returns to the processing in FIG. 4.

The terminal management information may be erased or disabled, for example, when the customer group leaves the store or when the payment of the fee corresponding to the seat is completed. This will allow the terminal apparatuses 2, 3 of another customer group to be managed while being associated with the seat.

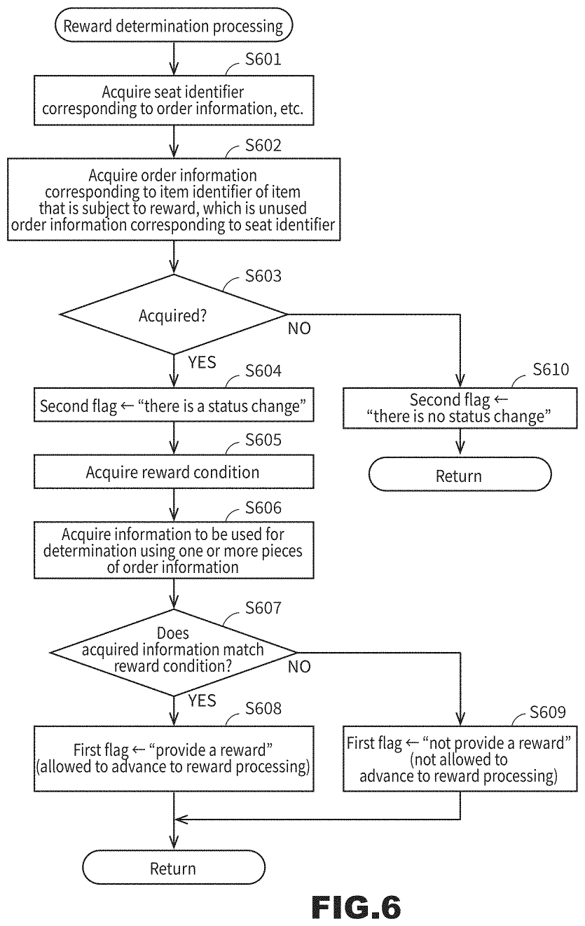

FIG. 6 is a flowchart showing an example of reward determination processing in this embodiment.

(Step S601) The determining unit 132 acquires a seat identifier corresponding to order information.

(Step S602) The determining unit 132 acquires order information corresponding to an item identifier of an item that is subject to a reward, which is unused order information corresponding to the acquired seat identifier. The unused order information is order information is order information that has been newly included in the processing target after previous reward determination processing was performed. Note that, in this embodiment, the order information that is to be acquired is order information for which seat supply information corresponding to the order information has already been received.

(Step S603) The determining unit 132 determines whether or not the corresponding order information was acquired in the processing of step S602. If the order information was acquired, the procedure advances to step S604, or otherwise the procedure advances to step S610.

(Step S604) The determining unit 132 sets a second flag regarding the status information to a value indicating the information “there is a status change”. Accordingly, when the procedure returns to the processing in FIG. 4, in step S410, the determining unit 132 determines that status information is to be transmitted. Then, some sort of status information is transmitted according to the processing following the reward determination processing.

(Step S605) The determining unit 132 acquires the reward condition stored in the reward condition storage unit 111.

(Step S606) The determining unit 132 acquires information (e.g., a unit price of an item, etc.) to be used for the determination using one or more pieces of order information corresponding to an item identifier of an item that is subject to a reward.

(Step S607) The determining unit 132 determines whether or not to perform the reward processing based on the acquired information. That is to say, the determining unit 132 determines whether or not the information acquired for the order information stored in the order information storage unit 113 matches the reward condition. If it is determined that the reward processing is to be performed (if it is determined that the information acquired for the order information matches the reward condition), the procedure advances to step S608, or otherwise the procedure advances to step S609.

(Step S608) The determining unit 132 sets a first flag regarding the reward processing to a value indicating the information “provide a reward”. That is to say, the determining unit 132 sets the first flag such that the procedure is allowed to advance to the reward processing. Subsequently, the procedure returns to the processing in FIG. 4. Accordingly, in step S411 of FIG. 4, for example, status information such as screen information for progressing the reward processing is acquired by the status information acquiring unit 133.

(Step S609) On the other hand, the determining unit 132 sets the first flag regarding the reward processing to a value indicating the information “not provide a reward”. That is to say, in this case, the procedure is not allowed to advance to the reward processing, and thus the first flag is set such that the procedure does not advance to the reward processing. Subsequently, the procedure returns to the processing in FIG. 4. Accordingly, in step S411 of FIG. 4, for example, status information such as user interface component information visually indicating remaining orders necessary to advance the procedure to the reward processing is acquired by the status information acquiring unit 133.

(Step S610) The determining unit 132 sets the second flag regarding the status information to a value indicating the information “there is no status change”. Subsequently, the procedure returns to the processing in FIG. 4. Accordingly, in step S410 of FIG. 4, the determining unit 132 does not determine that status information is to be transmitted, and thus the status information is not transmitted.

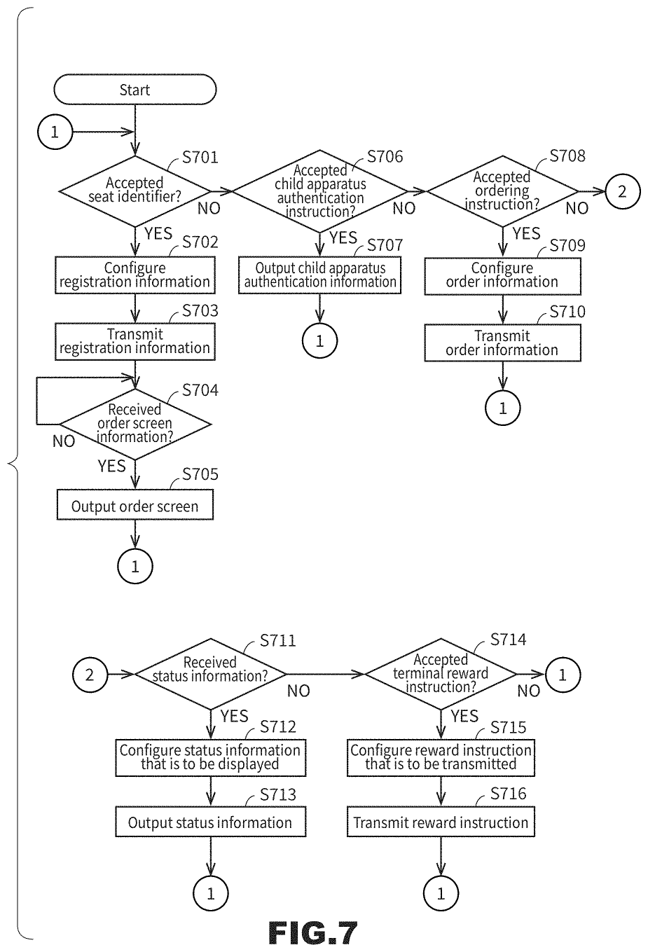

FIG. 7 is a flowchart showing an example of an operation of the terminal apparatus 2 serving as a parent apparatus in Embodiment 1.

In this embodiment, the terminal apparatus 2 operates as follows. Note that FIG. 7 shows an example of an operation from a state in which the terminal apparatus 2 is not associated with a seat.

(Step S701) The terminal accepting unit 22 accepts a seat identifier.

(Step S702) The terminal configuring unit 231 configures registration information, using the seat identifier accepted by the terminal accepting unit 22. That is to say, the terminal configuring unit 231 configures registration information by associating the acquired seat identifier with the terminal identifier of the terminal apparatus 2.

(Step S703) The terminal transmitting unit 24 transmits the configured registration information to the information processing apparatus 1.

(Step S704) The terminal receiving unit 25 receives order screen information, for example, from the information processing apparatus 1. The processing is put on standby until order screen information is received, and, when order screen information is received, the procedure advances to step S705. The received order screen information is, for example, stored in the terminal storage unit 21.

(Step S705) The terminal output unit 26 outputs an order screen using the order screen information. Subsequently, the procedure returns to step S701.

(Step S706) The terminal accepting unit 22 determines whether or not it has accepted child apparatus authentication instruction. If it is determined that it has accepted child apparatus authentication instruction, the procedure advances to step S707, or otherwise the procedure advances to step S708.

(Step S707) The terminal output unit 26 outputs the child apparatus authentication information. Subsequently, the procedure returns to step S701.

(Step S708) The terminal accepting unit 22 determines whether or not it has accepted an ordering instruction. If it is determined that it has accepted an ordering instruction, the procedure advances to step S709, or otherwise the procedure advances to step S711.

(Step S709) The terminal configuring unit 231 configures order information.

(Step S710) The terminal transmitting unit 24 transmits the order information configured by the terminal configuring unit 231, for example, to the information processing apparatus 1. Subsequently, the procedure returns to step S701.

(Step S711) The terminal acquiring unit 232 determines whether or not it has received status information transmitted from the information processing apparatus 1. If it has received status information, the procedure advances to step S712, or otherwise the procedure advances to step S714.

(Step S712) The terminal processing unit 23 configures status information that is to be displayed, using the received status information.

(Step S713) The terminal output unit 26 outputs the configured status information. Subsequently, the procedure returns to step S701.

(Step S714) The terminal accepting unit 22 determines whether or not it has accepted a terminal reward instruction. If it has accepted a terminal reward instruction, the procedure advances to step S715, or otherwise the procedure returns to step S701.

(Step S715) The terminal processing unit 23 configures a reward instruction that is to be transmitted to the information processing apparatus 1, according to the accepted terminal reward instruction.

(Step S716) The terminal transmitting unit 24 transmits the configured reward instruction to the information processing apparatus 1. Accordingly, the information processing apparatus 1 performs reward processing. Subsequently, the procedure returns to step S701.

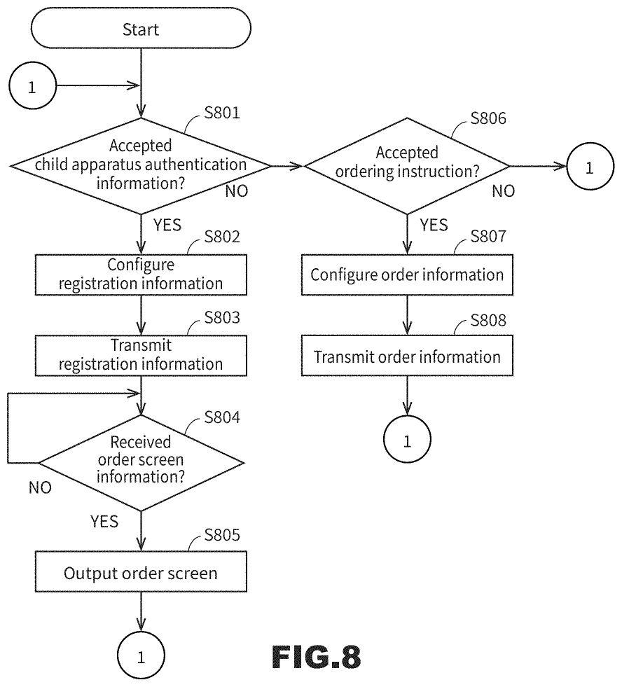

FIG. 8 is a flowchart showing an example of an operation of the second terminal apparatus 3 serving as a child apparatus in Embodiment 1.

In this embodiment, the second terminal apparatus 3 operates as follows. Note that FIG. 8 shows an example of an operation from a state in which the second terminal apparatus 3 is not associated with a seat.

(Step S801) The second terminal accepting unit 32 determines whether or not it has accepted child apparatus authentication information output by the terminal apparatus 2. If it is determined that it has accepted child apparatus authentication information, the procedure advances to step S802, or otherwise the procedure advances to step S806.

(Step S802) The second terminal processing unit 33 configures registration information, using the child apparatus authentication information accepted by the second terminal accepting unit 32.

(Step S803) The second terminal transmitting unit 34 transmits the configured registration information to the information processing apparatus 1.

(Step S804) The second terminal receiving unit 35 receives order screen information, for example, from the information processing apparatus 1. The processing is put on standby until order screen information is received, and, when order screen information is received, the procedure advances to step S805. The received order screen information is, for example, stored in the terminal storage unit 21.

(Step S805) The second terminal output unit 36 outputs an order screen using the order screen information. Subsequently, the procedure returns to step S801.

(Step S806) The second terminal accepting unit 32 determines whether or not it has accepted an ordering instruction. If it is determined that it has accepted an ordering instruction, the procedure advances to step S807, or otherwise the procedure returns to step S801.

(Step S807) The second terminal configuring unit 331 configures order information.

(Step S808) The second terminal transmitting unit 34 transmits the configured order information, for example, to the information processing apparatus 1. Subsequently, the procedure returns to step S801.

### Description of Specific Example Regarding Terminal Registration Processing and Reward Processing

Hereinafter, a specific example regarding terminal registration processing and reward processing in the information system A of this embodiment will be described. The following is an example and can be changed as appropriate.

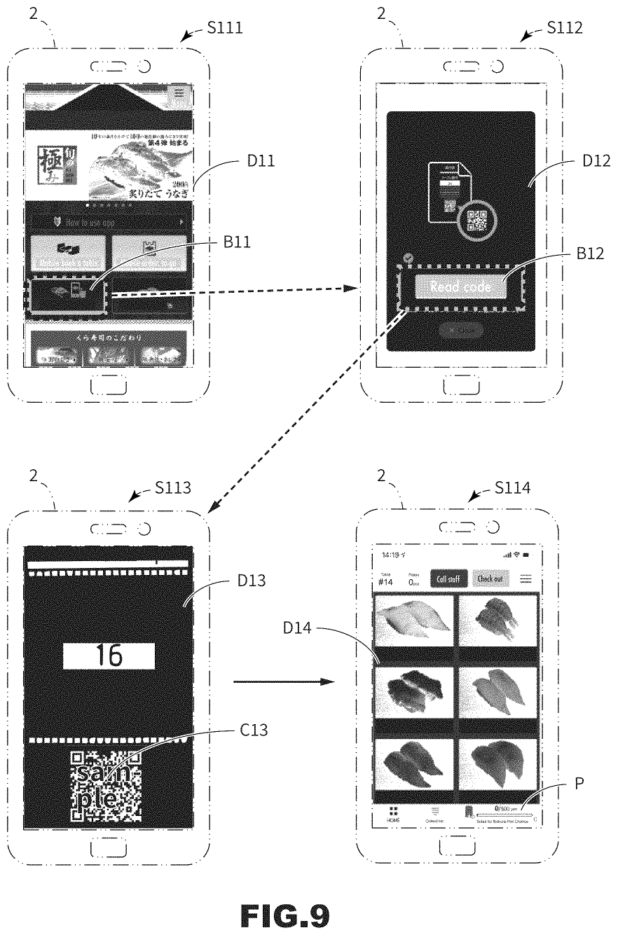

FIG. 9 is a first diagram showing a screen change example of the terminal apparatus 2 in this embodiment.

FIG. 9 shows a screen change example of the terminal apparatus 2 in the case in which terminal registration processing of the terminal apparatus 2 is performed. In the drawings described below, the dashed lines indicate the parts to be operated by the user.

In this embodiment, when a customer group enters a store, they are shown to their seats. Accordingly, one of the users of the customer group operates a predetermined application on the terminal apparatus 2 (step S111). The predetermined web page may be displayed using a web browser.

The user presses a predetermined button B11 in a displayed screen D11 in order to associate the terminal apparatus 2 with a seat. Any operation, such as tapping or voice operation, may be used as long as the operation is to select a function corresponding to the button. Then, a guidance screen D12 for accepting the seat identifier is displayed (step S112). The guidance screen D12 contains an indication that the user will subsequently read a predetermined two-dimensional code using the camera of the terminal apparatus 2, and a read button B13 for transitioning to a reading screen D13.

When an operation is performed on the read button B13, the reading screen D13 is displayed (step S113). The reading screen D13 displays an image captured by the camera of the mobile terminal 2. The user displays a predetermined registration code C13 on the reading screen D13. As the registration code C13, for example, a two-dimensional code printed on the information slip given to the user when being shown to the seat, a two-dimensional code attached to the seat, or the like, which is associated with the seat (i.e., corresponding to the seat identifier) can be used as appropriate. In the case in which the registration code C13 is contained in the reading screen D13, the terminal reception unit 22 recognizes the contents of the two-dimensional registration code C13. In the case in which an appropriate two-dimensional code 13 is recognized, terminal registration processing is performed in the information processing apparatus 1 by performing the above-described processing in the terminal apparatus 2.

In the case in which the terminal registration processing is performed, the order screen information is transmitted from the information processing apparatus 1 to the terminal apparatus 2, and thus an order screen D14 is displayed on the terminal apparatus 2 (step S14). Accordingly, it is possible for the user to place an order for an item using the terminal apparatus 2.

Apart of the order screen D14 contains status information P regarding the reward processing. In this specific example, the status information P is displayed in such a way that the reward condition and the degree of achievement thereof are easily understood by the user. That is to say, in the case in which the reward condition is to order 500 yen worth of the target item, the current order amount is displayed in contrast to “500 yen”. In addition, the status information P contains a progress bar indicating the degree of achievement of the order amount up to “500 yen”. With such status information P, the user can easily see how much longer it will take to reach the reward processing.

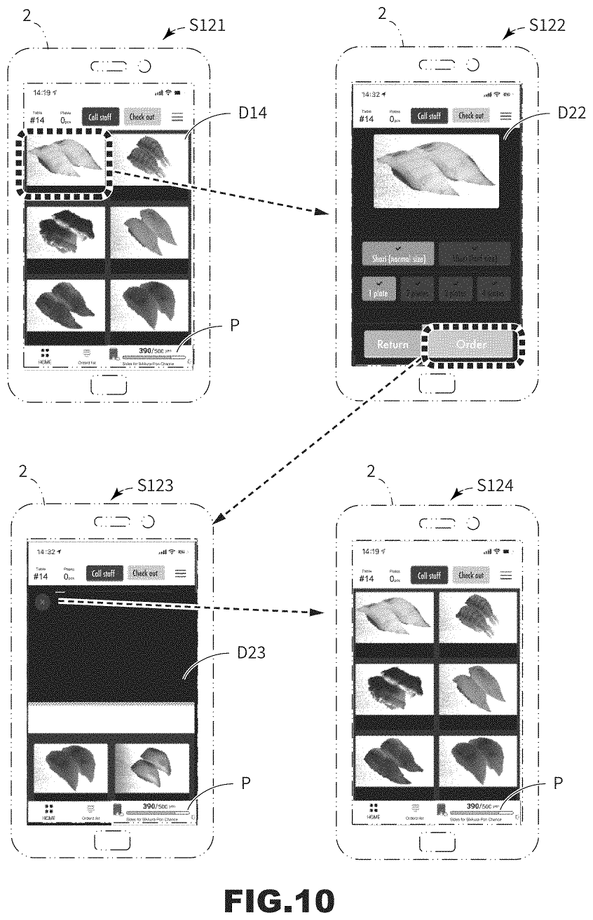

FIG. 10 is a second diagram showing a screen change example of the terminal apparatus 2 in this embodiment.

FIG. 10 shows a screen change example of the terminal apparatus 2 in the case in which an order is placed using the terminal apparatus 2.

Hereinafter, a case will be assumed in which an order screen D14 is displayed on the terminal apparatus 2 (step S121). In this example, in the case in which a selection operation for one item is performed, a second order screen D22 is displayed (step S122). On the second order screen D22, the number of items to be ordered and optional selections can be specified. In the case in which an operation to confirm the order is performed on the second order screen D12, an order completion screen D23 is displayed (step S123). Subsequently, as shown in step S124, the original order screen D14 is displayed (step S124).

In the specific example shown in FIG. 10, the status information P is displayed in the pre-order screen D14, the order completion screen D23, and the post-order screen D14. In this example, if an item that is not subject to the reward processing is ordered, the status information P does not change. In the case in which an item that is subject to the reward processing is ordered and the seat delivery information for the ordered item is received by the information processing apparatus 1, the status information P with an increase by the price of the ordered item is displayed.

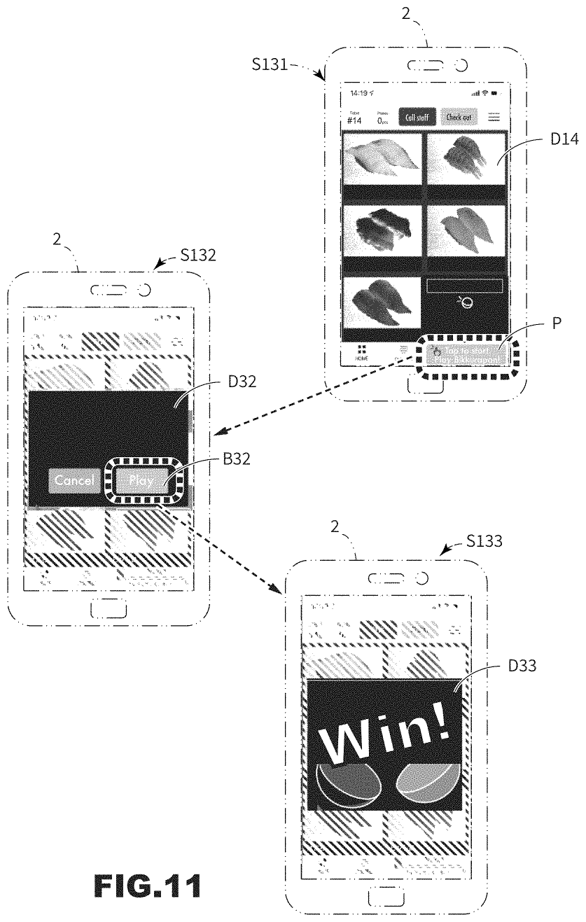

FIG. 11 is a third diagram showing a screen change example of the terminal apparatus 2 in this embodiment.

FIG. 11 shows a screen change example of the terminal apparatus 2 in the case in which a reward condition is satisfied.

If a reward condition is satisfied, the status information P displayed on the terminal apparatus 2 indicates that the reward processing can be performed (step S131). The user performs an operation on the status information P, thereby displaying a reward instruction screen D32 (step S132). The reward instruction screen D32 contains an indication that a drawing can be performed and a button B32 for performing the drawing (i.e., a button for giving a reward instruction). In the case in which the button B32 for performing a drawing is operated, the drawing is performed and a result display screen D33 is displayed (step S133). In the specific example shown in the drawing, the result display screen D33 indicates that the customer group was selected as a winner. Accordingly, the user can easily see that the customer group was selected as a winner.

After the reward processing is performed, the degree of achievement of the rewarding condition is reset. That is to say, the price of the item that is subject to the reward processing is reset.

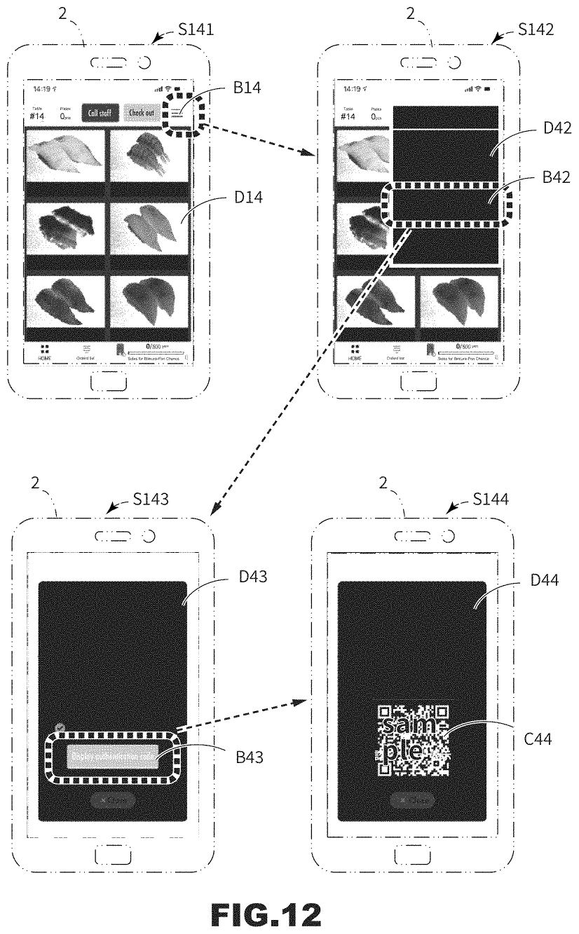

FIG. 12 is a fourth diagram showing a screen change example in terminal processing.

FIG. 12 shows a screen change example of the terminal apparatus 2 in the case in which child apparatus authentication instruction is accepted.

Hereinafter, a case will be assumed in which an order screen D14 is displayed on the terminal apparatus 2 (step S141). In this example, in the case in which a hamburger button B14 for the order screen D14 is operated, an operation menu screen D42 is displayed on the terminal apparatus 2 (step S142). The operation menu screen D42 contains a button B42 for giving a child apparatus authentication instruction. In the case in which the button B42 for giving a child apparatus authentication instruction is operated, a guidance screen D43 for an operation for authenticating a child apparatus is displayed on the terminal apparatus 2 (step S143). The guidance screen D43 contains an indication that the user will subsequently read a predetermined authentication code using the camera of the second terminal apparatus 3, and a display button B43 for transitioning to a child apparatus authentication information screen D44. When an operation is performed on the display button B43, the child apparatus authentication information screen D44 is displayed on the terminal apparatus 2 (step S144). The child apparatus authentication information screen D44 contains an authentication code C44, which is child apparatus authentication information. A user in the customer group can capture the authentication code C44 using the camera of the second terminal apparatus 3, thereby transmitting registration information regarding the second terminal apparatus 3 to the information processing apparatus 1, and causing the information processing apparatus 1 to perform terminal registration processing.

As described above, in this embodiment, order information regarding an order at the terminal apparatuses 2, 3 is used to reward a seat. Therefore, itis possible to provide users such as customers with the experience of using high value-added services using the terminal apparatuses 2 and 3.

In the reward processing, a reward is provided in the case which drawing processing is performed and a customer group is selected as a winner. Accordingly, it is possible to provide users with the enjoyment of joining a drawing. The status information regarding the reward processing is output to the terminal apparatus 2 serving as a parent apparatus. Accordingly, the user can be made aware of the possibility of acquiring a reward, and the enjoyment of the user can be increased. In addition, the user can determine whether or not to perform the reward processing, using the terminal apparatus 2 serving as a parent apparatus. Accordingly, the user can be made aware of the possibility of acquiring a reward, and the enjoyment of the user can be increased.

Multiple terminal apparatuses 2 and 3 can be made available in a customer group constituted by multiple users, and orders can be accepted and rewards can be given in group units. Thus, a higher value-added service experience can be provided. The terminal apparatuses 2 and 3 are used after being associated with the set. Therefore, various terminal apparatuses 2 and 3 owned by users can be used, and the users can be provided with a high value-added service experience using the terminal apparatuses 2 and 3.

In this embodiment, rewards for seats can be provided in cooperation with the prize output apparatus 4 used together with a conventionally used plate collecting apparatus. With respect to providing a reward using order information regarding orders at the terminal apparatuses 2 and 3, items that are subject to the reward processing can be limited. Thus, an attractive experience for a user can be provided to the user by combining the providing a reward using the order information regarding orders at the terminal apparatuses 2 and 3 and the providing a reward using the plate collecting apparatus.

The processing in this embodiment may be realized by software. The software may be distributed by software downloads or the like. Furthermore, the software may be distributed in a form where the software is stored in a storage medium such as a CD-ROM. The software that realizes the information processing apparatus 1 in this embodiment is the following sort of program. Specifically, this program is a program executable by a computer of the information processing apparatus 1, for causing the computer to function as: a reward condition storage unit in which a reward condition for performing reward processing, which is processing that provides a reward, is stored; an order information receiving unit that receives one or more pieces of order information, each of which is information regarding an order for an item, is information having seat specifying information for specifying a seat, and is information transmitted from a terminal apparatus; a determining unit that determines whether or not one or more pieces of order information received by the order information receiving unit and corresponding to one seat identifier for identifying a seat match the reward condition; and a reward processing unit that performs reward processing on the seat identified with the one seat identifier, in a case in which the determining unit determines that order information matches the reward condition.

Furthermore, the software that realizes the terminal apparatus 2 in this embodiment is the following sort of program. Specifically, this program is a program executable by a computer of the terminal apparatus 2, for causing the computer to function as: a terminal storage unit in which seat specifying information is stored; a terminal accepting unit that accepts an ordering instruction having an item identifier; a terminal configuring unit that configures order information containing the item identifier contained in the ordering instruction and the seat specifying information; a terminal transmitting unit that transmits the order information configured by the terminal configuring unit; a terminal acquiring unit that acquires status information for reward processing; and a terminal output unit that outputs the status information.

Furthermore, the software that realizes the second terminal apparatus 3 in this embodiment is the following sort of program. Specifically, this program is a program executable by a computer of the second terminal apparatus 3, for causing the computer to function as: a second terminal storage unit in which a second terminal identifier for identifying a child terminal apparatus is stored; a second terminal accepting unit that accepts child apparatus authentication information; and a second terminal transmitting unit that transmits registration information having the second terminal identifier and seat specifying information for specifying a seat, to an information processing apparatus, in response to acceptance of the child apparatus authentication information.

Others

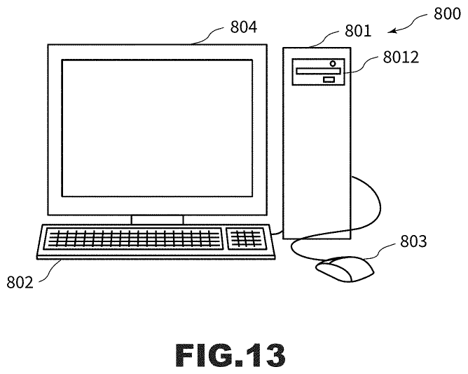

FIG. 12 is a schematic view of a computer system 800 in the foregoing embodiment. FIG. 13 is a block diagram of the computer system 800 in the foregoing embodiment.

These drawings show the configuration of a computer that executes the program described in this specification to realize the information processing apparatus and the like in the foregoing embodiment. The foregoing embodiment may be realized using computer hardware and a computer program executed thereon.

The computer system 800 includes a computer 801 including a CD-ROM drive, a keyboard 802, a mouse 803, and a monitor 804.

The computer 801 includes, in addition to the CD-ROM drive 8012, an MPU 8013, a bus 8014 connected to the CD-ROM drive 8012 and the like, a ROM 8015 in which a program such as a boot up program is stored, a RAM 8016 that is connected to the MPU 8013 and is a memory in which a command of an application program is temporarily stored and a temporary storage area is provided, and a hard disk 8017 in which an application program, a system program, and data are stored. Although not shown, the computer 801 may further include a network card that provides connection to a LAN.

The program for causing the computer system 800 to execute the functions of the information processing apparatus and the like in the foregoing embodiment may be stored in a CD-ROM 8101 that is inserted into the CD-ROM drive 8012, and be transmitted to the hard disk 8017. Alternatively, the program may be transmitted via a network (not shown) to the computer 801 and stored in the hard disk 8017. At the time of execution, the program is loaded into the RAM 8016. The program may be loaded from the CD-ROM 8101, or directly from a network.

The program does not necessarily have to include, for example, an operating system (OS) or a third party program to cause the computer 801 to execute the functions of the information processing apparatus and the like in the foregoing embodiment. The program may only include a command portion to call an appropriate function (module) in a controlled mode and obtain desired results. The manner in which the computer system 800 operates is well known, and thus a detailed description thereof has been omitted.

It should be noted that, in the program, in a transmitting step of transmitting information, a receiving step of receiving information, or the like, processing that is performed by hardware, for example, processing performed by a modem or an interface card in the transmitting step (processing that can be performed only by hardware) is not included.

Furthermore, the computer that executes this program may be a single computer, or may be multiple computers. That is to say, centralized processing may be performed, or distributed processing may be performed.

Furthermore, in the foregoing embodiment, it will be appreciated that two or more constituent elements in one apparatus may be physically realized by one medium.

In the foregoing embodiment, each process (each function) may be realized as centralized processing using a single apparatus (system), or may be realized as distributed processing using multiple apparatuses (in this case, the entire system constituted by multiple apparatuses that perform distributed processing may be regarded as one “apparatus”).

Furthermore, in the foregoing embodiment, information transmission performed between constituent elements may be such that, for example, if two constituent elements for transmitting information are physically different from each other, the transmission is performed by one of the constituent elements outputting the information and the other constituent element accepting the information, or alternatively, if two constituent elements for transmitting information are physically the same, the transmission is performed by shifting from a processing phase corresponding to one of the constituent elements to a processing phase corresponding to the other constituent element.

Furthermore, in the foregoing embodiment, information related to the processing that is performed by each constituent element, for example, information that is to be accepted, acquired, selected, generated, transmitted, or received by each constituent element, information such as a threshold value, a numerical expression, or an address used by each constituent element in the processing and the like may be retained in an unshown storage medium temporarily or for a long period of time even if not specified in the description above. Furthermore, the information may be accumulated in the unshown storage medium by each constituent element or by an unshown accumulating unit. Furthermore, the information may be read from the unshown storage medium by each constituent element or by an unshown reading unit.

Furthermore, in the foregoing embodiment, if information used in each constituent element or the like, for example, information such as a threshold value, an address, or various setting values used in each constituent element in the processing may be changed by a user, the user may be or may not be allowed to change such information as appropriate even if not specified in the description above. If the user is allowed to change such information, the change may be realized by, for example, an unshown accepting unit that accepts a change instruction from the user and an unshown changing unit that changes information according to the change instruction. The unshown accepting unit may accept the change instruction, for example, by accepting information from an input device, by receiving information transmitted via a communication line, or by accepting information read from a predetermined storage medium.

Furthermore, in the foregoing embodiment, each constituent element may be configured by dedicated hardware, or alternatively, constituent elements that can be realized by software may be realized by executing a program. For example, each constituent element may be realized by a program execution unit such as a CPU reading and executing a software program stored in a storage medium such as a hard disk or a semiconductor memory. At the time of executing the program, the program execution unit may execute the program while accessing the storage unit or the storage medium. Furthermore, this program may be executed by downloading from a server or the like, or may be executed by reading a program stored in a predetermined storage medium (e.g., an optical disk, a magnetic disk, a semiconductor memory, etc.). Furthermore, the program may be used as a program forming a program product. Furthermore, a computer that executes the program may be a single computer or may be multiple computers. That is to say, centralized processing may be performed, or distributed processing may be performed.

The present invention is not limited to the embodiment set forth herein. Various modifications are possible within the scope of the invention.

An embodiment may be configured by combining the foregoing embodiment with another configuration as appropriate. For example, the configuration of the foregoing embodiment is not limited to that described above, and constituent elements of the foregoing embodiment may be replaced by or combined with constituent elements of another embodiment as appropriate. Some of the constituent elements or the functions may be omitted in the foregoing embodiment.

### INDUSTRIAL APPLICABILITY

As described above, the information processing apparatus according to the present invention has an effect that it is possible to provide a reward to a seat, using order information regarding an order at a terminal apparatus, and thus this apparatus is useful as an information processing apparatus is useful as a server apparatus and the like.

### LIST OF REFERENCE NUMERALS

1 Information processing apparatus
2 Terminal apparatus
3 Second terminal apparatus
4 Prize output apparatus
11 Storage unit
12 Receiving unit
13 Processing unit
14 Transmitting unit
21 Terminal storage unit
22 Terminal accepting unit
23 Terminal processing unit
24 Terminal transmitting unit
25 Terminal receiving unit
26 Terminal output unit
31 Second terminal storage unit
32 Second terminal accepting unit
33 Second terminal processing unit
34 Second terminal transmitting unit
35 Second terminal receiving unit
36 Second terminal output unit
111 Reward condition storage unit
112 Terminal management information storage unit
113 Order information storage unit
121 Registration information receiving unit
122 Order information receiving unit
123 Seat delivery information receiving unit
131 Registration information accumulating unit
132 Determining unit
133 Status information acquiring unit
134 Reward processing unit
141 Status information transmitting unit
231 Terminal configuring unit
232 Terminal acquiring unit
331 Second terminal configuring unit
1341 Drawing processing part
1342 Reward providing part
A Information system

1. An information processing apparatus comprising:
a reward condition storage unit in which a reward condition for performing reward processing, which is processing that provides a reward, is stored;
an order information receiving unit that receives one or more pieces of order information, each of which is information regarding an order for an item, is information having seat specifying information for specifying a seat, and is information transmitted from a terminal apparatus;
a determining unit that determines whether or not one or more pieces of order information received by the order information receiving unit and corresponding to one seat identifier for identifying a seat match the reward condition; and
a reward processing unit that performs reward processing on the seat identified with the one seat identifier, in a case in which the determining unit determines that order information matches the reward condition.

2. The information processing apparatus according to claim 1, wherein the reward condition is a condition only regarding order information for predetermined one or more items out of two or more items.

3. The information processing apparatus according to claim 1, wherein the reward processing unit includes:
a drawing processing part that performs drawing processing that determines a drawing result; and
a reward providing part that performs reward providing processing that provides a reward to the seat identified with the one seat identifier.

4. The information processing apparatus according to claim 1, wherein the reward processing includes transmission processing of a prize output instruction to a prize output apparatus for outputting a prize.

5. The information processing apparatus according to claim 1, wherein the order information receiving unit receives order information having seat specifying information corresponding to a same seat, from two or more terminal apparatuses.

6. The information processing apparatus according to claim 1, further comprising:
a status information acquiring unit that acquires status information, which is information related to one or more pieces of order information corresponding to the one seat identifier and a reward condition and is information regarding an ordering status, using a determination result of the determining unit; and
a status information transmitting unit that transmits the status information to the terminal apparatus.

7. The information processing apparatus according to claim 6, wherein the status information transmitting unit transmits different types of status information between cases in which the determining unit gives a determination result indicating that order information matches the reward condition and a determination result indicating that order information does not match the reward condition, or transmits status information only in a case in which the determining unit gives a determination result indicating that order information matches the reward condition.

8. The information processing apparatus according to claim 6, further comprising:
a terminal management information storage unit in which one or more pieces of terminal management information having a seat identifier, one or at least two terminal identifiers, and parent-child distinguishing information for distinguishing one parent terminal apparatus from one or more child terminal apparatuses are stored,
wherein the status information transmitting unit transmits status information only to the parent terminal apparatus specified with the parent-child distinguishing information.

9. The information processing apparatus according to claim 8, further comprising:
a registration information receiving unit that receives registration information from one or at least two terminal apparatuses; and
a registration information accumulating unit that accumulates a terminal identifier contained in the registration information received by the registration information receiving unit, in the terminal management information storage unit, in association with a seat identifier contained in the registration information received by the registration information receiving unit,
wherein the determining unit determines whether or not two or more pieces of order information with a same seat identifier that is paired with a terminal identifier, which is seat specifying information contained in the order information received by the order information receiving unit, match the reward condition.

10. The information processing apparatus according to claim 1, further comprising:
a seat delivery information receiving unit that receives seat delivery information, which is information having a seat identifier and an item identifier and is information indicating that an item identified with an item identifier contained in order information has been delivered to a seat,
wherein the determining unit determines whether or not one or more pieces of order information corresponding to a seat identifier contained in the seat delivery information, the order information being one or more pieces of order information corresponding to an item identifier contained in the seat delivery information, match the reward condition.

11. The information processing apparatus according to claim 1,
wherein the order information receiving unit also receives one or more pieces of second order information, each of which is information having a seat identifier and is order information from an apparatus different from the terminal apparatus, and
the determining unit determines whether or not one or more pieces of order information transmitted from the terminal apparatus and one or more pieces of second order information corresponding to a same seat identifier as that of the one or more pieces of order information match the reward condition.

12. A terminal apparatus comprising:
a terminal storage unit in which seat specifying information is stored;
a terminal accepting unit that accepts an ordering instruction having an item identifier;
a terminal configuring unit that configures order information containing the item identifier contained in the ordering instruction and the seat specifying information;
a terminal transmitting unit that transmits the order information configured by the terminal configuring unit;
a terminal acquiring unit that acquires status information for reward processing; and
a terminal output unit that outputs the status information.

13. The terminal apparatus according to claim 12,
wherein the status information is screen information indicating that the procedure is allowed to advance to the reward processing,
the terminal accepting unit accepts a terminal reward instruction, which is an instruction to screen information output by the terminal output unit and is an instruction to advance the procedure to the reward processing, and
the terminal apparatus further comprises a terminal transmitting unit that transmits a reward instruction, which is an instruction to perform reward processing, in response to acceptance of the terminal reward instruction.

14. The terminal apparatus according to claim 12,
wherein child apparatus authentication information for authenticating one or more child terminal apparatuses is stored in the terminal storage unit, and
the terminal output unit outputs the child apparatus authentication information.

15. A second terminal apparatus comprising:
a second terminal storage unit in which a second terminal identifier for identifying a child terminal apparatus is stored;
a second terminal accepting unit that accepts child apparatus authentication information; and
a second terminal transmitting unit that transmits registration information having the second terminal identifier and seat specifying information for specifying a seat, to an information processing apparatus, in response to acceptance of the child apparatus authentication information.

16. The second terminal apparatus according to claim 15, further comprising:
a second terminal receiving unit that receives order screen information of two or more items, in response to transmission of the registration information; and
a second terminal output unit that outputs the order screen information.
